(19) United States
(12) Patent Application Publication
(10) Pub. No.: US 2002/0014303 A1
(43) Pub. Date: Feb. 7, 2002

(54) Method of producing liquid crystal element and liquid crystal element

(76) Inventors: Shoji Kotani, Otsu-Shi (JP); Masakazu Okada, Kyoto-Shi (JP); Masashi Nishikado, Osaka-Shi (JP); Hideaki Ueda, Kishiwada-Shi (JP)

Correspondence Address: SIDLEY AUSTIN BROWN & WOOD, 717 NORTH HARWOOD, SUITE 3400, DALLAS, TX, 75201, US

(21) Appl. No.: 09/894,654

(22) Filed: Jun. 28, 2001

(30) Foreign Application Priority Data
Jun. 30, 2000 (JP) 2000-198906

(51) Int. Cl. B29C 65/00

(52) U.S. Cl. 156/286; 156/290

(57) ABSTRACT

A method of producing a multilayer LC display element including a plurality of LC display cells stacked together and each filled with an LC material, comprising the steps of: (a) forming a multilayer empty cell structure by stacking a plurality of empty cells each having a pair of substrates opposed together and having a peripheral portion sealed except for at least one LC material inlet opened externally; and (b) supplying the LC material by vacuum supply through the LC material inlet into each of the empty cells forming the multilayer empty cell structure, wherein said empty cells formed in the step (a) are provided at circumferentially different positions with the liquid crystal material inlets, respectively.

### CROSS-REFERENCE TO RELATED APPLICATION

The invention is based on Japanese patent application No. 2000-198906 filed in Japan on Jun. 30, 2000, the entire content of which is hereby incorporated by reference.

### BACKGROUND OF THE INVENTION

1. Field of the Invention

The present invention relates to a method of producing a liquid crystal display element and a structure of the liquid crystal display element, and particularly relates to a method of producing a stack-type or multilayer liquid crystal display element including a plurality of liquid crystal display cells, which are stacked or layered together and each are filled with liquid crystal material, as well as a structure of the liquid crystal display element.

2. Description of the Background Art

A liquid crystal display cell filled with a liquid crystal material generally has a pair of substrates, between which the liquid crystal material is filled. The liquid crystal material between the substrates is confined by a sealing applied to the periphery of the substrate pair. The sealing is usually formed of a seal wall held between the substrates.

The above liquid crystal cell may be produced in a method shown in FIG. 20. In this method, a seal wall SL serving also as an adhesive is formed on one of paired substrates S1 and S2, and a liquid crystal material LC is arranged on one end of the substrate S2 placed on a base BS. One end of the other substrate S1 is placed over the above end, and both the substrates are held between a member R such as a roller and the base BS. The substrates thus arranged are adhered together while spreading the liquid crystal material LC from the above one end toward the other end in the space between the substrates. If necessary, heat is applied when adhering the substrates together.

The liquid crystal display cell can be obtained by the processing of bonding the substrates and hardening the seal wall while filling the liquid crystal material. For example, the liquid crystal display cells, which are produced in the above manner, and can perform display in red, green and blue, respectively, may be stacked to provide the multilayer liquid crystal display element capable of display in full color.

However, by bonding the substrates substantially simultaneously with filling of the liquid crystal material, an unhardened seal wall material comes into contact with the liquid crystal material so that impurities are mixed into the liquid crystal material, resulting in deterioration of display characteristics of the liquid crystal display cell and thus multilayer liquid crystal display element.

Further, the liquid crystal material, which is being spread in a space between the substrates during the substrate bonding operation, may leak through the sealing wall, and may flow along the outer side of the sealing wall so that it may adhere to the outer surface(s) of the substrates. This requires a step for sufficiently removing the adhered liquid crystal material from each liquid crystal display cell before stacking the liquid crystal display cells. Thereafter, the liquid crystal display cells must be stacked for completing the multilayer liquid crystal display element. Accordingly, much time is required for producing the multilayer liquid crystal display element.

### SUMMARY OF THE INVENTION

An object of the invention is to provide a method of producing a multilayer liquid crystal display element including a plurality of liquid crystal display cells stacked together and each filled with a liquid crystal material, and particularly a method of producing a multilayer liquid crystal display element, in which mixing of impurities into a predetermined liquid crystal material in each of the stacked liquid crystal display cells is sufficiently suppressed, and therefore good display characteristics are achieved.

Another object of the invention is to provide a method of producing a multilayer liquid crystal display element including a plurality of liquid crystal display cells stacked together and each filled with a liquid crystal material, and particularly a method allowing easy and efficient producing a multilayer liquid crystal display element.

Still another object of the invention is to provide a multilayer liquid crystal display element including a plurality of liquid crystal display cells stacked together and each filled with a liquid crystal material, and particularly a multilayer liquid crystal display element, in which mixing of impurities into a predetermined liquid crystal material in each of the stacked liquid crystal display cells is sufficiently suppressed, and therefore good display characteristics are achieved.

Yet another object of the invention is to provide a multilayer liquid crystal display element including a plurality of liquid crystal display cells stacked together and each filled with a liquid crystal material, and particularly a multilayer liquid crystal display element allowing easy and efficient producing.

The invention provides the following methods of producing a multilayer liquid crystal display element as well as the following structure of the multilayer liquid crystal display element.

(1) Method of Producing the Multilayer Liquid Crystal Display Element

(1-1) First Producing Method

A method of producing a multilayer liquid crystal display element including a plurality of liquid crystal display cells stacked together and each filled with a liquid crystal material, comprising the steps of:

(a) forming a multilayer empty cell structure by stacking a plurality of empty cells each including a pair of substrates opposed together and each having a peripheral portion between the substrates sealed except for at least one liquid crystal material inlet opened externally; and

(b) supplying the liquid crystal materials by a vacuum supply through the liquid crystal material inlets into the empty cells, respectively, wherein

said empty cells formed in the step (a) are provided at circumferentially different positions with the liquid crystal material inlets, respectively.

(1-2) Second Producing Method

A method of producing a multilayer liquid crystal display element including a plurality of liquid crystal display cells stacked together and each filled with a liquid crystal material, comprising the steps of:

(a) forming a multilayer empty cell structure by stacking empty cells each prepared by arranging a seal wall between a pair of substrates opposed together to surround a plurality of liquid crystal material filling regions, each of the seal walls having at least one liquid crystal material inlet, at least one of the liquid crystal material inlets of the plurality of seal walls being externally opened, the liquid crystal material filling region(s) surrounded by the seal wall(s) not provided with the externally opened liquid crystal material inlet being in communication with at least one of the liquid crystal material filling region(s) surrounded by the seal wall(s) having the externally opened liquid crystal material inlet, and the externally opened liquid crystal material inlet of each of the empty cells being arranged on a periphery of the multilayer empty cell structure, and being located at a position different from those of the other empty cells;

(b) supplying the liquid crystal materials by a vacuum supply through the externally opened liquid crystal material inlets into the empty cells, respectively; and

(c) dividing the multilayer cell structure into the individual multilayer liquid crystal display elements after the step (b).

(1-3) Third Producing Method

A method of producing a multilayer liquid crystal display element including a plurality of liquid crystal display cells stacked together and each filled with a liquid crystal material, comprising the steps of:

(a) forming a plurality of empty cell groups, each of the groups including a plurality of empty cells of a same kind, each of the empty cells of each of the groups having a pair of substrates opposed together and a sealing applied to a peripheral portion between the substrates except for at least one liquid crystal material inlet opened externally;

(b) forming the liquid crystal display cells by stacking and holding the plurality of empty cells of the same kind, and simultaneously supplying the liquid crystal material by a vacuum supply through the liquid crystal material inlets into the stacked empty cells belonging to each of the empty cell groups; and

(c) forming the multilayer liquid crystal display element by selecting and stacking the multiple kinds of liquid crystal display cells among the liquid crystal display cells obtained in the step (b).

(1-4) Fourth Producing Method

A method of producing a multilayer liquid crystal display element including a plurality of liquid crystal display cells stacked together and each filled with a liquid crystal material, comprising the steps of:

(a) forming multiple kinds of empty cell groups, each of the groups including a plurality of empty cells of a same kind, each of the empty cells of each of the groups prepared by arranging a seal wall between a pair of substrates opposed together to surround a plurality of liquid crystal material filling regions, each of the seal walls having at least one liquid crystal material inlet, at least one of the liquid crystal material inlets of each seal wall being externally opened, the liquid crystal material filling region(s) surrounded by the seal wall not provided with the externally opened liquid crystal material inlet being in communication with at least one of the liquid crystal material filling region(s) surrounded by the seal wall having the externally opened liquid crystal material inlet;

(b) forming liquid crystal display cells of multi-continuous type by stacking and holding the plurality of empty cells of the same kind, and simultaneously supplying the liquid crystal material by a vacuum supply through the externally opened liquid crystal material inlets into the stacked empty cells belonging to each of the empty cell groups; and

(c) forming the multilayer liquid crystal display elements by dividing the liquid crystal display cells of the multiple continuous type into the individual liquid crystal display cells, and by selecting and stacking the multiple kinds of the liquid crystal display cells, or stacking the plurality of liquid crystal display cells of the multiple continuous type to form multilayer liquid crystal display elements of multiple continuous type, and dividing the multilayer liquid crystal display elements of the multiple continuous type into the individual multilayer liquid crystal display elements.

In any one of the foregoing methods of producing the multilayer liquid crystal display elements, the empty cells are formed, and thereafter the liquid crystal material is supplied into the empty cells. Therefore, melting of the seal material into the liquid crystal material can be sufficiently suppressed, and the predetermined liquid crystal material can be easily supplied into each empty cell. Therefore, it is possible to provide the multilayer liquid crystal display element, in which mixing of impurities into the predetermined liquid crystal material in each of the liquid crystal display cells to be stacked is suppressed, and thereby good display characteristics can be achieved.

As compared with the case, in which liquid crystal display cells are stacked, each of the cells being obtained by a method including the step of bonding the substrates and simultaneously filling the liquid crystal display cell to be stacked with liquid crystal material, it is possible to reduce significantly an amount of the liquid crystal material adhered to outer surfaces of each liquid crystal display cell and the produced multilayer liquid crystal display element, and therefore the operation of removing the liquid crystal material from the outer surfaces can be easy, resulting in easy and efficient producing of the multilayer liquid crystal display element.

(2) Multilayer Liquid Crystal Display Element

A multilayer liquid crystal display element comprising a plurality of liquid crystal display cells stacked together, wherein

each of the liquid crystal display cells includes:

a liquid crystal filling a space between a pair of substrates, and

a seal wall arranged between the substrates, surrounding the liquid crystal for preventing leakage of the liquid crystal, and being provided with a closed opening initially opened for supplying the liquid crystal into the space defined by the substrates and the seal wall, and

the positions of the closed openings of the liquid crystal display cells are different from each other in the circumferential direction of the liquid crystal display element.

This element can be easily and efficiently produced by the method of producing the multilayer liquid crystal display element according to the invention. Further, mixing of impurities into the predetermined liquid crystal material of each of the stacked liquid crystal display cells is sufficiently suppressed, and therefore good display characteristics can be achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross section of an example of a multilayer liquid crystal display element;

FIG. 2(A) is an elevation of an empty cell for a liquid crystal display cell for red display, FIG. 2(B) is an elevation of an empty cell for a liquid crystal display cell for green display, and FIG. 2(C) is an elevation of an empty cell for a liquid crystal display cell for blue display;

FIG. 3 is a perspective view of a multilayer empty cell structure formed of three kinds of empty cells stacked together and shown in FIGS. 2(A), 2(B) and 2(C), respectively;

FIG. 4 shows a schematic structure of an example of a device for supplying a predetermined liquid crystal material into each empty cell in the multilayer empty cell structure shown in FIG. 3;

FIGS. 5(A)-5(C) show a manner of supplying the predetermined liquid crystal materials into the empty cells by the device shown in FIG. 4;

FIGS. 6(A)-6(C) show another example of the empty cells, FIG. 6(A) is an elevation of an empty cell for a liquid crystal display cell for red display, FIG. 6(B) is an elevation of an empty cell for a liquid crystal display cell for green display, and FIG. 6(C) is an elevation of an empty cell for a liquid crystal display cell for blue display;

FIG. 7 is an elevation of a multilayer empty cell structure formed of three kinds of empty cells stacked together and shown in FIGS. 6(A), 6(B) and 6(C), respectively;

FIG. 8 fragmentarily shows a schematic structure of an example of a device for supplying a predetermined liquid crystal material into each empty cell in the multilayer empty cell structure shown in FIG. 7;

FIGS. 9(A)-9(C) show a manner of supplying the predetermined liquid crystal materials into the empty cells by the device shown in FIG. 8;

FIGS. 10(A)-10(C) show still another example of the empty cells, FIG. 10(A) is an elevation of an empty cell for a liquid crystal display cell for red display, FIG. 10(B) is an elevation of an empty cell for a liquid crystal display cell for green display, and FIG. 10(C) is an elevation of an empty cell for a liquid crystal display cell for blue display;

FIG. 11(A) shows a schematic structure of an example of a device for supplying a predetermined liquid crystal material into each empty cell in the multilayer empty cell structure formed of three kinds of empty cells shown in FIGS. 10(A)-10(C), and Fig. 11(B) shows a state where the device in FIG. 11(A) supplies the predetermined liquid crystal materials into the empty cells;

FIG. 12 shows an example, in which the predetermined liquid crystal material is simultaneously supplied into the same kind of empty cells of the plurality of multilayer empty cell structures stacked together and each shown in FIG. 3;

FIG. 13 shows an example, in which the predetermined liquid crystal material is simultaneously supplied into the same kind of empty cells of the plurality of multilayer empty cell structures stacked together and each shown in FIG. 7;

FIG. 14 shows an example, in which the predetermined liquid crystal materials are simultaneously supplied into the empty cells of the plurality of multilayer empty cell structures stacked together and each shown in FIGS. 11(A) and 11(B);

FIG. 15 shows an example, in which the liquid crystal material is supplied into the empty cells in the manner similar to that shown in FIGS. 11(A) and 11(B) while moving the liquid crystal material inlet of each empty cell in the multilayer empty cell structure shown in FIG. 3;

FIG. 16 shows an example, in which the predetermined liquid crystal material is simultaneously supplied into the same kind of empty cells stacked together and shown in FIG. 2;

FIG. 17 shows another example, in which the predetermined liquid crystal material is simultaneously supplied into the same kind of empty cells stacked together and shown in FIG. 2;

FIGS. 18(A)-18(C) show further different examples of the empty cell, respectively;

FIGS. 19(A)-19(F) show further different examples of the empty cell, respectively; and

FIG. 20 shows an example of producing the liquid crystal display cell, and particularly processing including a step of bonding substrates while filling a space between the substrates with the liquid crystal material.

### DESCRIPTION OF THE PREFERRED EMBODIMENTS

Description will be given on embodiments of the invention, and more specifically, several types of method of producing a multilayer liquid crystal display element and others.

(1) First Type of Producing Method

A method of producing a multilayer liquid crystal display element including a plurality of liquid crystal display cells stacked together and each filled with a liquid crystal material, comprising the steps of:

(a) forming a multilayer empty cell structure by stacking a plurality of empty cells each including a pair of substrates opposed together and each having a peripheral portion between the substrate pair sealed except for at least one liquid crystal material inlet opened externally; and

(b) supplying the liquid crystal materials by a vacuum supply through the liquid crystal material inlets into the empty cells, wherein

the empty cells of the multilayer empty cell structure formed in the step (a) are provided at its periphery with the liquid crystal material inlets located at circumferentially different positions, respectively, and

the vacuum supply of the liquid crystal material in the liquid crystal material supplying step is performed by successively locating the liquid crystal material inlets of the respective empty cells of the multilayer empty cell structure at a liquid crystal material supply region in a predetermined position.

According to the first type of method, the empty cells of the multilayer empty cell structure are provided at its periphery with the liquid crystal material inlets located at circumferentially different positions, respectively, and the vacuum supply of the liquid crystal material is performed by successively locating the liquid crystal material inlets of the respective empty cells at the liquid crystal material supply region in the predetermined position. Therefore, mixing of the liquid crystal materials corresponding to the empty cells can be suppressed.

(2) Second Type of Producing Method

A method of producing a multilayer liquid crystal display element including a plurality of liquid crystal display cells stacked together and each filled with a liquid crystal material, comprising the steps of:

(a) forming a multilayer empty cell structure by stacking empty cells prepared by arranging a seal wall between a pair of substrates opposed together to surround a plurality of predetermined liquid crystal material filling regions, each of the seal walls having at least one liquid crystal material inlet, at least one of the liquid crystal material inlets of each seal wall being externally opened, the liquid crystal material filling region(s) surrounded by the seal wall not provided with the externally opened liquid crystal material inlet being in communication with at least one of the liquid crystal material filling region(s) surrounded by the seal wall having the externally opened liquid crystal material inlet;

(b) supplying the liquid crystal material by a vacuum supply through the externally opened liquid crystal material inlet into each of the empty cells; and

(c) dividing the multilayer cell structure into the individual mutilayer liquid crystal display elements after the step (b), wherein

the step (a) is performed such that the externally opened liquid crystal material inlet of each of the empty cells is arranged on a periphery of the multilayer empty cell structure, and is located at a position different from those of the other empty cells, and

the vacuum supply of the liquid crystal material in the step (b) is performed by successively locating the externally opened liquid crystal material inlets of the respective empty cells of the multilayer empty cell structure at a liquid crystal material supply region in a predetermined position.

According to the second type of method, mixing of the liquid crystal materials corresponding to the empty cells can be suppressed, and further a large number of multilayer liquid crystal display elements can be produced efficiently.

The second type of method is suitable to mass production of the multilayer liquid crystal display element.

In the first and second types of methods, and particularly, in a typical example of the step of forming the multilayer empty cell structure, the multilayer empty cell structure may be formed such that the externally opened liquid crystal material inlet of each of the empty cells is located on a side or a corner of the multilayer empty cell structure different from sides and corners having the externally opened liquid crystal material inlet of the other empty cells.

In the first and second types of methods, and particularly, in a typical example of the step of vacuum-supplying the liquid crystal material into each of the empty cells of the multilayer empty cell structure,

the supply of the liquid crystal material into each of the empty cells of the multilayer empty cell structure may be performed by arranging the multilayer empty cell structure in a predetermined vacuum atmosphere for achieving a predetermined vacuum state in the empty cell to be filled with the liquid crystal material, sinking the externally opened liquid crystal material inlet of the empty cell in the liquid crystal material within a container of the liquid crystal material to be supplied into the empty cell, and increasing an ambient pressure of the liquid crystal material above the vacuum ambient pressure for supplying the liquid crystal material into the empty cell.

In another typical example, the supply of the liquid crystal material into each of the empty cells of the multilayer empty cell structure may be performed by arranging the multilayer empty cell structure in a predetermined vacuum atmosphere for achieving a predetermined vacuum state in the empty cell to be filled with the liquid crystal material, locating the externally opened liquid crystal material inlet of the empty cell at the liquid crystal material supply region in the predetermined position, arranging the predetermined liquid crystal material corresponding to the empty cell on the externally opened liquid crystal material inlet of the empty cell, and increasing an ambient pressure of the arranged liquid crystal material above the vacuum ambient pressure for supplying the liquid crystal material into the empty cell.

(3) Third Type of Producing Method

A method of producing a multilayer liquid crystal display element including a plurality of liquid crystal display cells stacked together and each filled with a liquid crystal material, comprising the steps of:

(a) forming a multilayer empty cell structure by stacking a plurality of empty cells each including a pair of substrates opposed together and each having a peripheral portion between the substrate pair sealed except for at least one liquid crystal material inlet opened externally; and

(b) supplying the liquid crystal materials by a vacuum supply through the liquid crystal material inlets into the empty cells, respectively, wherein the empty cells of the multilayer empty cell structure formed in the step (a) are provided at different positions on the same side of the multilayer empty cell structure with the liquid crystal material inlets, and

the vacuum supply of the liquid crystal material in the step (b) is performed by simultaneously locating the liquid crystal material inlets of the respective empty cells of the multilayer empty cell structure at a liquid crystal material supply region in a predetermined position.

According to the third type of method, the predetermined liquid crystal materials can be simultaneously arranged on the liquid crystal material inlets of the respective cells of the multilayer empty cell structure, and the liquid crystal materials can be simultaneously supplied into the respective empty cells. Therefore, the time required for supplying the liquid crystal material can be reduced.

(4) Fourth Type of Producing Method

A method of producing a multilayer liquid crystal display element including a plurality of liquid crystal display cells stacked together and each filled with a liquid crystal material, comprising the steps of:

(a) forming a multilayer empty cell structure by stacking empty cells each prepared by arranging a seal walls between a pair of substrates opposed together to surround a plurality of predetermined liquid crystal material filling regions, each of the seal walls having at least one liquid crystal material inlet, at least one of the liquid crystal material inlets of each seal wall being externally opened, the liquid crystal material filling region(s) surrounded by each seal wall not provided with the externally opened liquid crystal material inlet being in communication with at least one of the liquid crystal material filling region(s) surrounded by the seal wall having the externally opened liquid crystal material inlet;

(b) supplying the liquid crystal materials by a vacuum supply through the externally opened liquid crystal material inlets into the empty cells, respectively; and

(c) dividing the multilayer cell structure into the individual multilayer liquid crystal display elements after the liquid crystal material supply, wherein

the empty cells of the multilayer empty cell structure formed in the step (a) are provided at different positions on the same side of the multilayer empty cell structure with the liquid crystal material inlets, and

the vacuum supply of the liquid crystal material in the step (b) is performed by simultaneously locating the externally opened liquid crystal material inlets of the respective empty cells of the multilayer empty cell structure at a liquid crystal material supply region in a predetermined position.

According to the fourth type of method, the time required for supplying the liquid crystal material can be reduced, similarly to the third type of method. According to the fourth type of method, a large number of multilayer liquid crystal display elements can be produced efficiently. The fourth type of method is suitable to mass production of the multilayer liquid crystal display element.

In the third and fourth types of methods, and particularly, in a typical example of the step of vacuum-supplying the liquid crystal material into each of the empty cells of the multilayer empty cell structure,

the supply of the liquid crystal material into each of the empty cells of the multilayer empty cell structure may be performed by arranging the multilayer empty cell structure in a predetermined vacuum atmosphere for achieving a predetermined vacuum state in the empty cells, arranging the predetermined liquid crystal materials corresponding to the respective empty cells on the externally opened liquid crystal material inlets of the respective empty cells, and increasing an ambient pressure of the arranged liquid crystal materials above the vacuum ambient pressure for supplying the liquid crystal materials into the empty cells.

In any one of the first to fourth types of methods, such a manner may be employed that

the step of forming the multilayer empty cell structure is executed to form the plurality of multilayer empty cell structures, the plurality of multilayer empty cell structures are held in a stacked fashion and the step of supplying the liquid crystal material is performed simultaneously for all the multilayer empty cell structures.

This allows further efficient producing of the multilayer liquid crystal display element.

Since the plurality of multilayer empty cell structures are held in the stacked fashion, the area where the liquid crystal material can be arranged is increased even in the first and second types of method, and particularly in cases where the supply of the liquid crystal material into each of the empty cells of the multilayer empty cell structures is performed by arranging the multilayer empty cell structures in a predetermined vacuum atmosphere for achieving a predetermined vacuum state in the empty cells to be filled with the liquid crystal material, locating the externally opened liquid crystal material inlets of the empty cells at the liquid crystal material supply region in the predetermined position, arranging the predetermined liquid crystal material corresponding to the empty cells on the externally opened liquid crystal material inlets of the empty cells, and increasing an ambient pressure of the arranged liquid crystal material above the vacuum ambient pressure for supplying the liquid crystal material into the empty cells. Further, the above area where the liquid crystal material can be arranged is increased even in the case of employing the third and fourth types of methods. This facilitates arrangement of a required amount of liquid crystal material.

Since the plurality of multilayer empty cell structures are held in the stacked fashion, this increases an area for arranging a sealing member, which is arranged for closing the externally opened liquid crystal material inlets after supply of the liquid crystal material. Therefore, the required amount of sealing member can be arranged easily.

Naturally, in each type of the method of producing the multilayer liquid crystal display element, the liquid crystal material inlet of each empty cell is finally closed by an appropriate sealing member after supplying the liquid crystal material thereinto.

(5) Fifth Type of Producing Method

A method of producing a multilayer liquid crystal display element including a plurality of liquid crystal display cells stacked together and each filled with a liquid crystal material, comprising the steps of:

(a) forming a plurality of empty cell groups, each of the groups including a plurality of empty cells of the same kind, each of the empty cells of each of the groups having a pair of substrates opposed together and a sealing applied to a peripheral portion between the substrates except for at least one liquid crystal material inlet opened externally;

(b) forming the liquid crystal display cells by stacking and holding the plurality of empty cells of the same kind, and simultaneously supplying the liquid crystal material by vacuum supply through the liquid crystal material inlets into the stacked empty cells belonging to each of the empty cell groups; and

(c) forming the multilayer liquid crystal display element by selecting and stacking the multiple kinds of liquid crystal display cells among the liquid crystal display cells obtained in the liquid crystal display cell forming step.

(6) Sixth Type of Producing Method

A method of producing a multilayer liquid crystal display element including a plurality of liquid crystal display cells stacked together and each filled with a liquid crystal material, comprising the steps of:

(a) forming multiple kinds of empty cell groups, each of the groups including a plurality of empty cells of the same kind, each of the empty cells of each of the groups prepared by arranging a seal wall between a pair of substrates opposed together to surround a plurality of predetermined liquid crystal material filling regions, each of the seal walls having at least one liquid crystal material inlet, at least one of the liquid crystal material inlets of each seal wall being externally opened, the liquid crystal material filling region(s) surrounded by the seal wall not provided with the externally opened liquid crystal material inlet being in communication with at least one of the liquid crystal material filling region(s) surrounded by the seal wall having the externally opened liquid crystal material inlet;

(b) forming liquid crystal display cells of multi-continuous type by stacking and holding the plurality of empty cells of the same kind, and simultaneously supplying the liquid crystal material by vacuum supply through the externally opened liquid crystal material inlets into the stacked empty cells belonging to each of the empty cell groups; and

(c) forming the multilayer liquid crystal display element by (1) dividing the liquid crystal display cells of the multiple continuous type into the individual liquid crystal display cells, and by selecting and stacking the multiple kinds of the liquid crystal display cells, or (2) stacking the plurality of liquid crystal display cells of the multiple continuous type to form the multilayer liquid crystal display element of the multiple continuous type, and dividing the multilayer liquid crystal display element of the multiple continuous type into the individual multilayer liquid crystal display elements.

In either of the fifth and sixth types of methods, the plurality of multilayer liquid crystal display elements are produced in such a manner that the empty cells of the same kind among the multiple kinds of empty cells for forming the multilayer liquid crystal display elements are held in the stacked fashion, and each group of the empty cells held and stacked together is subjected to the processing of simultaneously supplying the liquid crystal material into the empty cells belonging to the same group via the externally opened liquid crystal material inlets. Therefore, the liquid crystal material supply time can be reduced, and thus can reduce the time required for producing the plurality of multilayer liquid crystal display elements.

Since the plurality of multilayer empty cells are held in the stacked fashion, this increases an area for arranging the liquid crystal material, which is arranged on the external liquid crystal material inlets of the empty cells. Therefore, the required amount of liquid crystal material can be arranged easily. Further, the above manner increases an area for arranging a sealing member, which is arranged for closing the externally opened liquid crystal material inlets after supply of the liquid crystal material. Therefore, the required amount of sealing member can be arranged easily.

Both the fifth and sixth types of methods, and particularly, the sixth type of method is suitable to mass production of the multilayer liquid crystal display element.

For example, in the step of forming the liquid crystal display cells, the supply of the liquid crystal material into each of the stacked empty cells of the same group may be performed by arranging each group of the stacked empty cells in a predetermined vacuum atmosphere for achieving a predetermined vacuum state in the empty cells belonging to the same cell group, simultaneously sinking the externally opened liquid crystal material inlets of the empty cells in the liquid crystal material within a container to be supplied into the empty cells, and increasing an ambient pressure of the liquid crystal material above the vacuum ambient pressure for supplying the liquid crystal material into the empty cells.

Further, in the step of forming the liquid crystal display cells, the supply of the liquid crystal material into each of the stacked empty cells of the same group may be performed by arranging the empty cells in a predetermined vacuum atmosphere for achieving a predetermined vacuum state in the empty cells belonging to the same group, arranging the liquid crystal material on the externally opened liquid crystal material inlets of the empty cells, and increasing an ambient pressure of the arranged liquid crystal material above the vacuum ambient pressure for supplying the liquid crystal material into the empty cells.

In any one of the first to sixth types of methods already described, the plurality of empty cells for forming the multilayer liquid crystal display element may be filled with the liquid crystal materials of different colors, respectively. For example, the cells may be filled with the liquid crystal materials for display in red, green and blue so that the multilayer liquid crystal display element for full color display can be obtained.

For the purpose of, e.g., performing display in desired colors by the respective liquid crystal display cells, the liquid crystal materials of different compositions may be supplied into the different kinds of empty cells forming the multilayer liquid crystal display element, respectively.

The liquid crystal material supplied into each of the empty cells forming the multilayer liquid crystal display element may include a chiral nematic liquid crystal.

The liquid crystal material may be the chiral nematic liquid crystal exhibiting a cholesteric phase, whereby the multilayer liquid crystal display element of the reflection type can be achieved.

In any one of the foregoing types of methods, the material of the substrates forming the empty cell may be made of film such as resin film. In the second, fourth and sixth types of methods and others including the dividing step, a film substrate such as a resin film substrate, which allows easy division, may be employed.

In the multilayer liquid crystal display element, the substrates other than that, which is located on the side remotest from an image observation side, may be generally transparent. The substrate located on the remotest side may also be transparent.

In this case, a light absorber layer may be arranged on the outer surface of the substrate on the remotest side, if necessary.

Description will now be given on examples of the multilayer liquid crystal display element and the producing method with reference to the drawings.

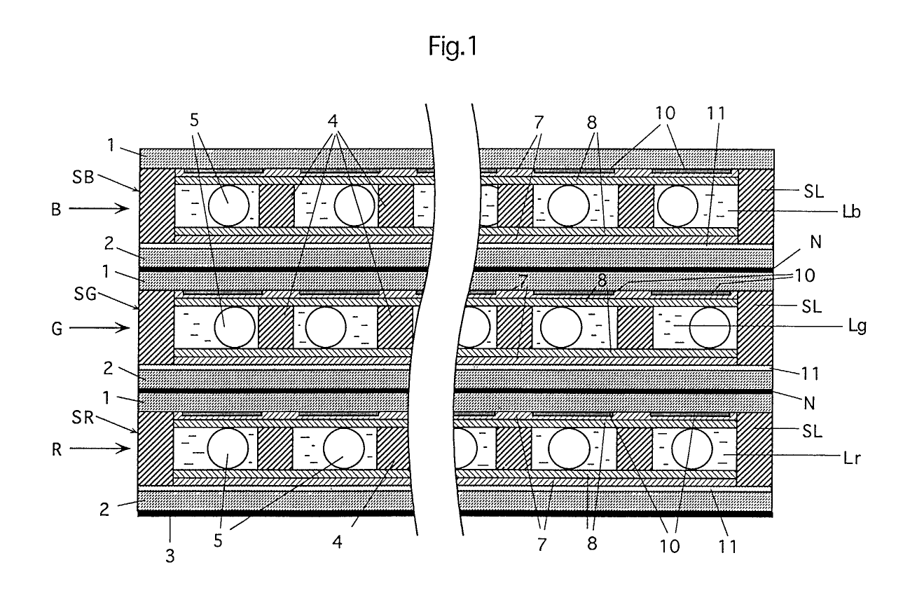

FIG. 1 is a schematic cross section of a multilayer liquid crystal display element of a reflection type.

A multilayer cell structure shown in FIG. 1 has a three-layer structure formed of liquid crystal display cells R, G and B capable of display in red (R), green (G) and blue (B), respectively.

Each liquid crystal display cell includes two substrates 1 and 2, which are made of transparent resin film, and have transparent electrodes 10 and 11, respectively, and also includes columnar resin structures 4 adhered to the substrates 1 and 2 as well as spacers 5. These resin structures 4 and the spacers 5 keep a predetermined space between the substrates.

The space between the substrates 1 and 2 is filled with a liquid crystal material. Liquid crystal materials Lr, Lg and Lb are conditioned to perform selective reflection in red, green and blue in the respective liquid crystal display cells.

The respective liquid crystal materials may be made of different components, or may be made of the same components of which composition ratios are different from each other.

The three layers of empty panels for forming the multilayer liquid crystal display element are formed in the following manners.

First, the transparent electrodes 10 are formed on the transparent resin film substrate 1, and an insulating film 7 is formed on the electrodes 10. An orientation film 8 is formed thereon, and the spacers 5 are dispersed and adhered to the film 8.

The transparent electrodes 11 are formed on the transparent resin film 2, and an insulating film 7 and an orientation film 8 are formed on the electrodes 11. Further, thermoplastic resin is applied by screen printing onto the orientation film 8 so that the columnar resin structures 4 are formed.

Then, a seal wall material is applied by screen printing onto the periphery of the substrate 1 to form a seal wall SL of a predetermined height. At the same time, a liquid crystal material inlet, which is externally opened, is formed in a predetermined position.

Then, these substrates 1 and 2 are bonded together, and heat is applied to harden the seal wall material so that a single layer of the empty cell is formed.

In this manner, empty cells SR, SG and SB are formed. The empty cell SR is used for a liquid crystal display cell R for red display. The empty cell SG is used for a liquid crystal display cell G for green display. The empty cell SB is used for a liquid crystal display cell B for blue display. These cells SR, SG and SB are layered in this order, and are adhered together by an adhesive N so that the multilayer empty cell structure is formed.

The multilayer liquid crystal display element shown in FIG. 1 may be produced in such a manner that the predetermined liquid crystal materials are supplied into the empty cells SR, SG and SB to form the respective liquid crystal display cells R, G and B, and then these liquid crystal display cells are stacked and adhered together, or in such a manner that the multilayer empty cell structure is first prepared, and then the predetermined liquid crystal materials are supplied into the empty cells SR, SG and SB of the multilayer empty cell structure.

In either of the above cases, a light absorber layer 3 is formed on the outer surface of the empty cell SR. The light absorber layer may be formed in an appropriate stage other than the above.

Description will now be given on an example of producing of the multilayer liquid crystal display element.

In the following example of the producing method, the empty cells are formed as follows.

An inorganic insulating film of 2000 Åin thickness, which is made of silicon oxide, titanium oxide and zilconium oxide, is formed on the transparent electrodes of ITO arranged on the transparent polycarbonate (PC) film substrate. A polyimide orientation film of 800 Åin thickness is formed on the insulating film, and the spacers of 9 μm in diameter (produced by Sekisui Finechemical Co., Ltd.) are dispersed on the orientation film.

An insulating film and an orientation film similar to the above are formed on the transparent ITO electrodes on the other transparent PC film substrate, and thermoplastic resin, i.e., polyurethane resin in this example, is applied by screen printing on the orientation film to form the columnar resin structures.

Then, a seal wall material XN21 (produced by Mitsui Chemicals Co., Ltd.) is applied by screen printing onto the periphery of the substrate carrying the dispersed spacers so that the seal wall of a predetermined height is formed. When forming this seal wall, the liquid crystal material inlet, which is opened externally, is also formed.

Thereafter, these substrates are bonded together, and are heated at 1500° C. for one hour so that the seal wall is hardened, and the single layer of the empty panel is produced.

In this manner, the empty cells SR, SG and SB for the liquid crystal display cells R, G and B are produced.

In some embodiments, the empty cells SR, SG and SB thus prepared are stacked, and are mutually adhered by transparent adhesive or transparent adhesive sheets arranged between the neighboring cells. Further, the light absorber layer is formed on the outer surface of the empty cell SR. Thereby, the multilayer empty cell structure is produced.

The liquid crystal materials are conditioned as follows.

Predetermined amounts of chiral materials S-811 (produced by Merk & Co.) are added to nematic liquid crystal A having refractive index anisotropy Δn of 0.187 and dielectric constant anisotropy Δε of 4.47, nematic liquid crystal B (Δn=0.177, Δε=5.33) and nematic liquid crystal C (Δn=0.20, Δε=6.25) so that liquid crystal compositions Lr, Lg and Lb for display in red, green and blue are prepared. The compositions Lr, Lg and Lb can reflect the light of the wavelengths of about 680 nm, 560 nm and 480 nm, respectively.

In the respective embodiments described below, melting of the seal material into the liquid crystal material is sufficiently suppressed, and the liquid crystal material corresponding to the empty cell can be easily supplied into each empty cell. Thereby, mixing of impurities into the predetermined liquid crystal material in each of the stacked liquid crystal display cells is suppressed, and therefore the multilayer liquid crystal display element can have good display characteristics.

As compared with the case, in which liquid crystal display cells are stacked by a method including the step of bonding the substrates and simultaneously filling the cells to be stacked with liquid crystal material, it is possible to reduce significantly an amount of the liquid crystal material adhered to the outer surfaces of each liquid crystal cell and the produced multilayer liquid crystal cell structure, and therefore the operation of removing the liquid crystal material from the outer surfaces can be easy, resulting in easy and efficient producing of the multilayer liquid crystal display element.

Accordingly, the multilayer liquid crystal display element thus produced have good display characteristics.

### EXAMPLE 1

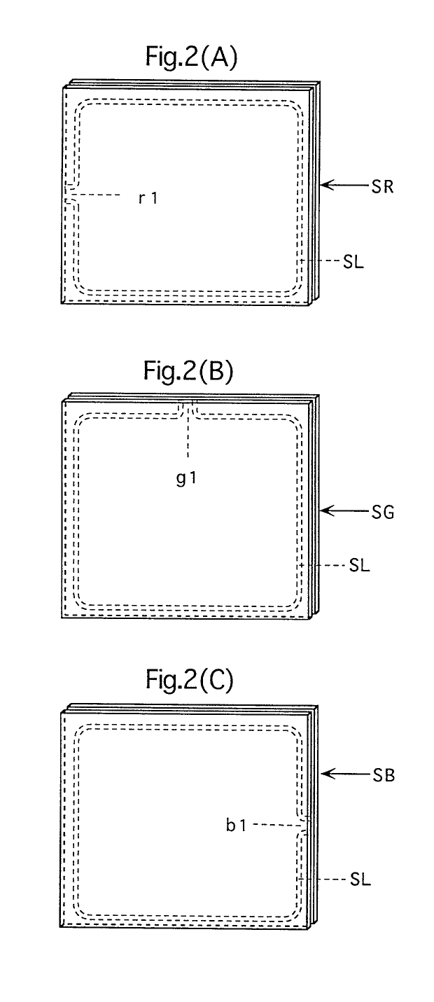

The producing method already described is executed to form the empty cells SR, SG and SB shown in FIGS. 2(A), 2(B) and 2(C), respectively. These empty cells have the same area and the rectangular form. A seal wall SL of the empty cell SR is provided at its left side in FIG. 2(A) with a liquid crystal material inlet r1 opened externally. A seal wall SL of the empty cell SG is provided at its upper side in FIG. 2(B) with a liquid crystal material inlet g1 opened externally. A seal wall SL of the empty cell SB is provided at its right side in FIG. 2(C) with a liquid crystal material inlet b1 opened externally.

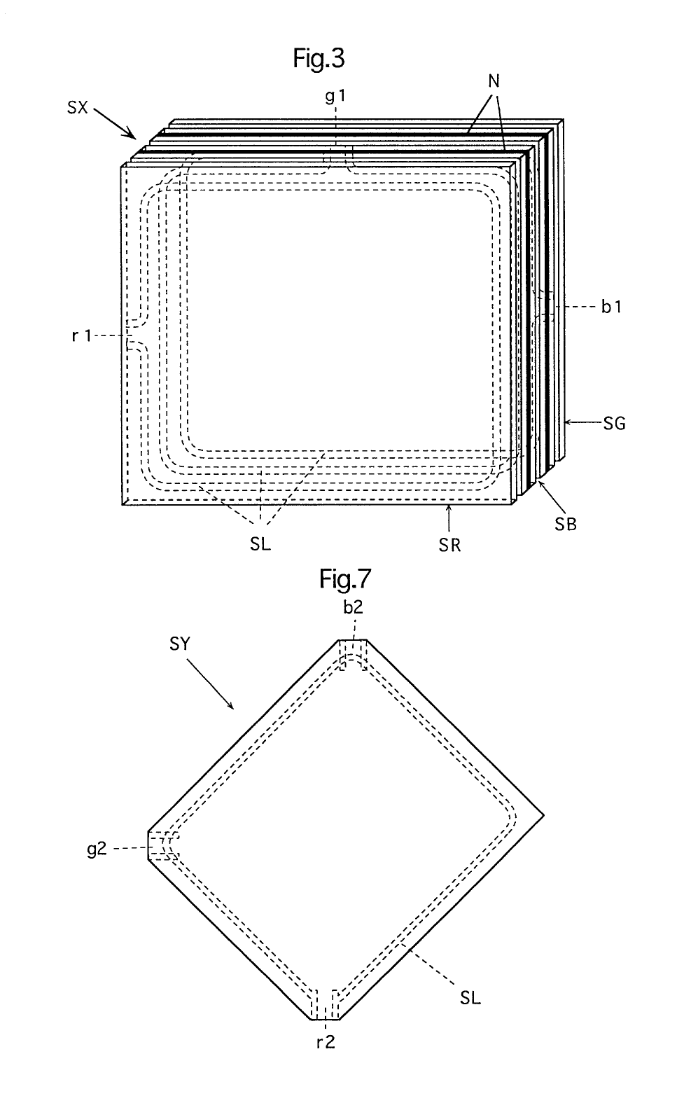

These empty cells are stacked, and the neighboring empty cells are adhered together by a transparent adhesive sheet N so that a multilayer empty cell structure SX shown in FIG. 3 is formed. In the multilayer empty cell structure SX, the liquid crystal material inlets r1, g1 and b1 are located on the different sides of the empty cell structure SX, respectively.

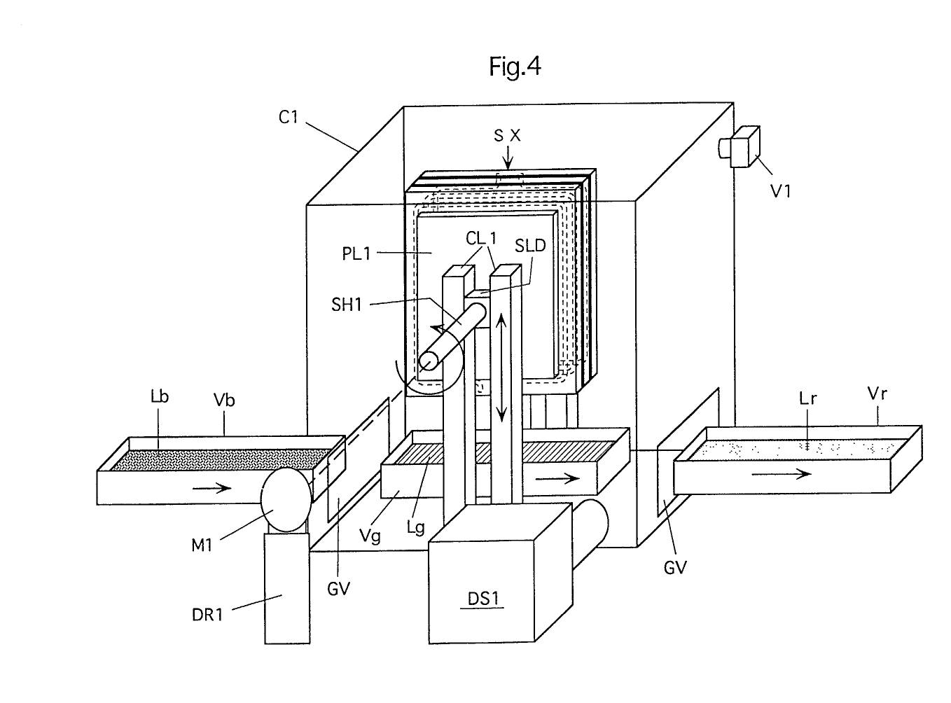

The multilayer empty cell structure SX is located in a vacuum chamber C1 as shown in FIG. 4, and is held between a pair of plates PL1 (only one is shown). Each plate PL1 is supported by a shaft SH1, which is rotatably supported by a vertically movable slider SLD, and extends therethrough. An electric motor M1 can angularly rotate the shaft SH1. A vertical drive device DR1 can vertically move the slider SLD, shaft SH1 and motor M1 along a column CL1.

A vacuum chamber C1 is provided with an exhausting (vacuum) device DS1 and a nitrogen gas supply valve V1 connected to a nitrogen gas source (not shown) as well as left and right gate valves GV. By opening the gate valves GV, containers Vr, Vg and Vb of the liquid crystal materials Lr, Lg and Lb can be moved into and from the vacuum chamber C1 by a container transporting device (not shown).

For example, the container Vr accommodating the liquid crystal material Lr is first placed within the vacuum chamber C1 in the above manner, and the gate valves GV are closed. Then, the exhaust device DS1 operates to reduce the pressure in the vacuum chamber and attain a predetermined vacuum pressure of about 10³ Torr. The motor M1 turns the whole multilayer empty cell structure SX by a predetermined angle to position the liquid crystal material inlet r1 of the empty cell SR downward.

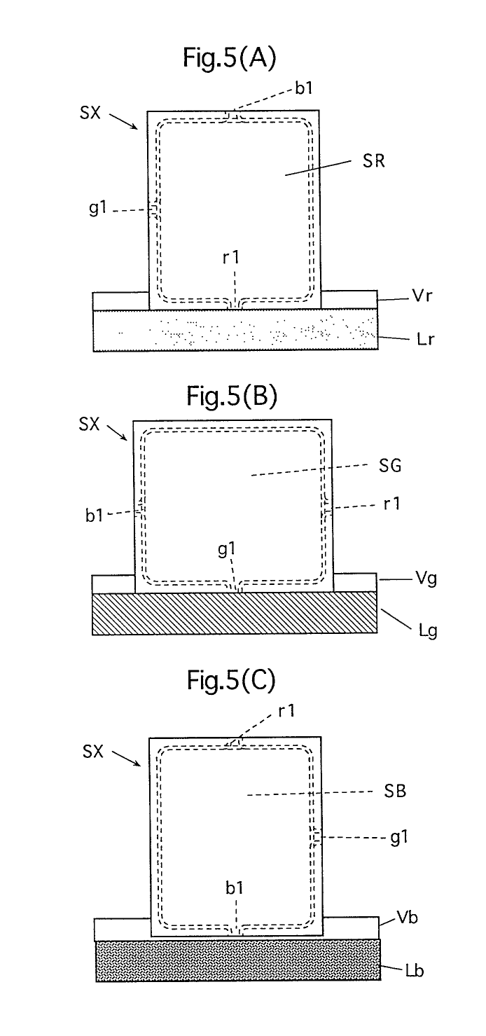

Thereafter, the vertical drive device DR1 lowers the multilayer empty cell structure SX to locate the inlet r1 of the empty cell SR in the liquid crystal material Lr as shown in FIG. 5(A).

Then, the valve V1 of the vacuum chamber C1 is opened to supply the nitrogen gas into the vacuum chamber so that an atmospheric pressure is substantially achieved in the vacuum chamber. Thereby, the liquid crystal material Lr is supplied into the empty cell SR through the inlet r1 by the pressure difference between the ambient pressure of the liquid crystal material and the pressure in the empty cell SR.

Thereafter, the inlet r1 is closed by a sealant Photolec (produced by Sekisui Finechemical Co., Ltd.).

In a similar manner, the inlet g1 of the empty cell SG is immersed in the liquid crystal material Lg within the container Vg so that the liquid crystal material is supplied into the empty cell SG by the pressure difference, as shown in FIG. 5(B). Thereafter, the inlet g1 is closed by the sealant Photolec. Likewise, the inlet b1 of the empty cell SB is immersed in the liquid crystal material Lb within the container Vb so that the liquid crystal material is supplied into the empty cell SB by the pressure difference, as shown in FIG. 5(C). Thereafter, the inlet b1 is closed by the sealant Photolec. In this manner, the multilayer liquid crystal display element is achieved.

According to the embodiment 1, the empty cells SR, SG and SB are provided at different positions on the periphery of the multilayer empty cell structure with the liquid crystal material inlets, respectively, and the liquid crystal material inlets of the respective empty cells are successively arranged in the liquid crystal material supply region at the predetermined position for supplying the liquid crystal material. Therefore, mixing of the liquid crystal materials of the empty cells can be suppressed.

### EXAMPLE 2

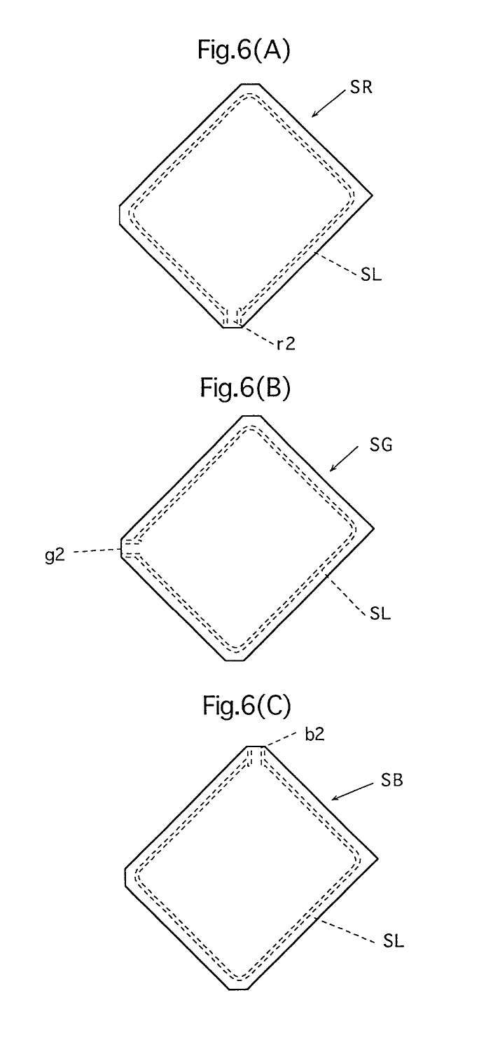

The producing method already described is executed to form the empty cells SR, SG and SB shown in FIGS. 6(A), 6(B) and 6(C), respectively. These empty cells have the same area and the rectangular form. The seal wall SL of each of empty cells SR, SG and SB is provided at its corner with one liquid crystal material inlet r2, g2 or b2, which is opened externally and thus is in communication with an external space.

These empty cells are stacked, and are adhered together by the transparent adhesive sheets each arranged between the neighboring cells so that a multilayer empty cell structure SY shown in FIG. 7 is formed. In the multilayer empty cell structure SY, the liquid crystal material inlets r2, g2 and b2 are located on the different corners of the structure SY, respectively.

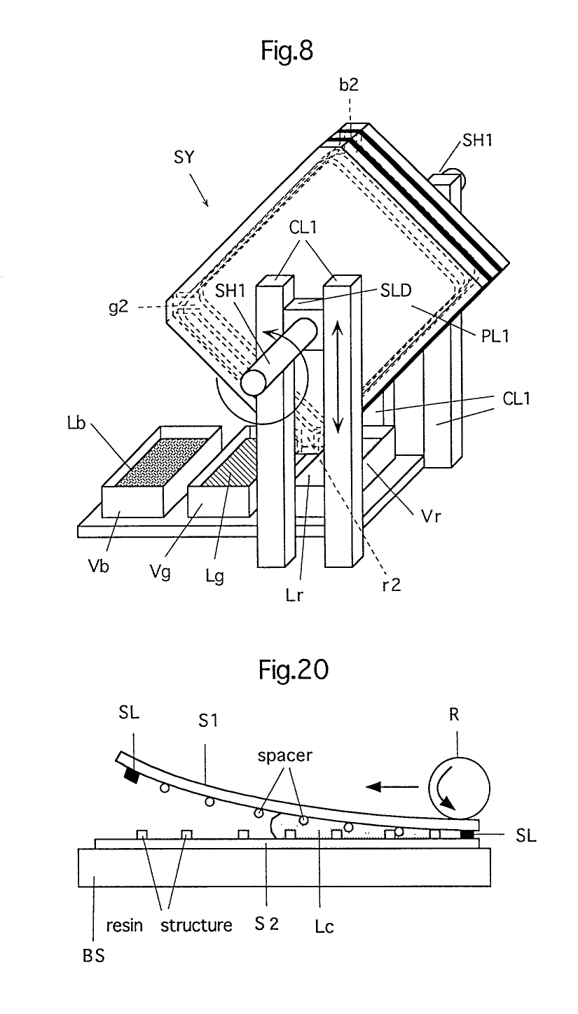

The multilayer empty cell structure SY is disposed in a vacuum chamber similar to that shown in FIG. 4, and is held between the paired plates PL1 (only one is shown) as shown in FIG. 8. In the manner similar to that shown in FIG. 4, each plate PL1 is supported by a shaft SH1, which is rotatably supported by the vertically movable slider SLD, and extends therethrough. The electric motor (M1) can angularly rotate the shaft SH1. The vertical drive device (DR1) can vertically move the slider SLD, shaft SH1 and motor (M1) along the column CL1.

The vacuum chamber (not shown), which is similar to that shown in FIG. 4, is provided with an exhausting device and a nitrogen gas supply valve as well as the left and right gate valves similar to those shown in FIG. 4. By opening the gate valves, containers Vr, Vg and Vb of the liquid crystal materials Lr, Lg and Lb can be moved into and from the vacuum chamber.

For example, the container Vr accommodating the liquid crystal material Lr is first placed within the vacuum chamber in the above manner, and the gate valves are closed. Then, the exhaust device operates to reduce the pressure in the vacuum chamber and attain a predetermined vacuum pressure of about 10⁻³ Torr. The electric motor turns the whole multilayer empty cell structure SY by a predetermined angle to position the liquid crystal material inlet r2 of the empty cell SR downward.

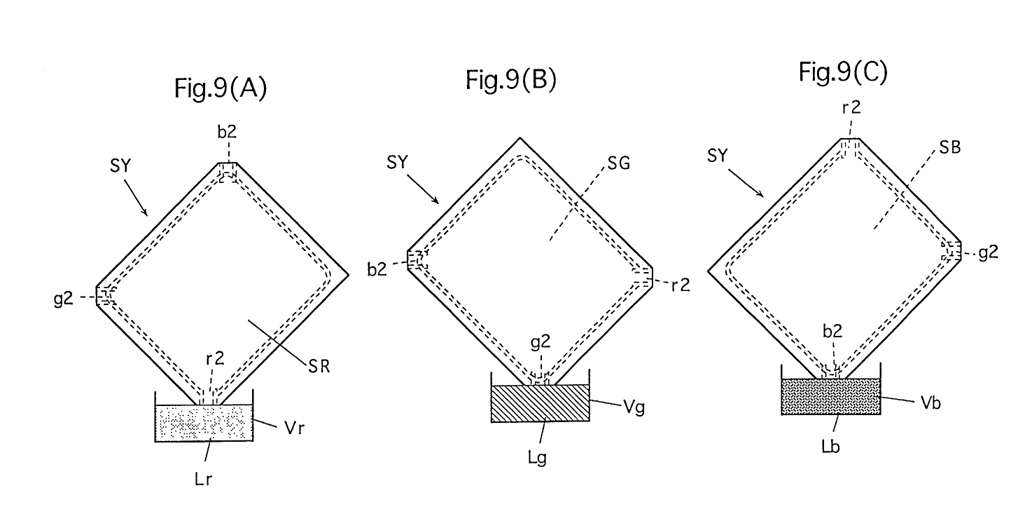

Thereafter, the vertical drive device lowers the multilayer empty cell structure SY to locate the inlet r2 of the empty cell SR in the liquid crystal material Lr as shown in FIG. 9(A).

Then, the valve (V1) of the vacuum chamber (C1) is opened to supply the nitrogen gas into the vacuum chamber so that an atmospheric pressure is substantially achieved in the vacuum chamber. Thereby, the liquid crystal material Lr is supplied into the empty cell SR through the inlet r2 by the pressure difference between the ambient pressure of the liquid crystal material and the pressure in the empty cell SR.

Thereafter, the inlet r2 is closed by the sealant Photolec (produced by Sekisui Finechemical Co., Ltd.).

In a similar manner, the inlet g2 of the empty cell SG is immersed in the liquid crystal material Lg within the container Vg so that the liquid crystal material is supplied into the empty cell SG by the pressure difference, as shown in FIG. 9(B). Thereafter, the inlet g2 is closed by the sealant Photolec. Likewise, the inlet b2 of the empty cell SB is immersed in the liquid crystal material Lb within the container Vb so that the liquid crystal material is supplied into the empty cell SB by the pressure difference, as shown in FIG. 9(C). Thereafter, the inlet b2 is closed by the sealant Photolec. In this manner, the multilayer liquid crystal display element is achieved.

According to the embodiment 2, mixing of the liquid crystal materials of the empty cells can be suppressed more easily than the embodiment 1. Further, the smearing of the multilayer empty cell structure SY with the liquid crystal material can be prevented more effectively than the embodiment 1.

### EXAMPLE 3

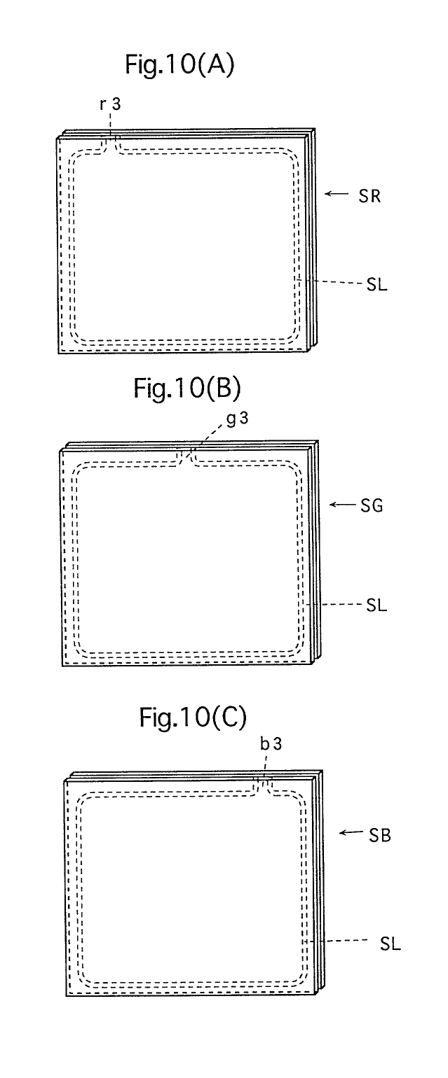

The producing method already described is executed to form the empty cells SR, SG and SB shown in FIGS. 10(A), 10(B) and 10(C), respectively. These empty cells have the same area and the rectangular form. The seal wall SL of each of empty cells SR, SG and SB is provided at its side with one liquid crystal material inlet r3, g3 or b3, which is opened externally and thus is in communication with an external space.

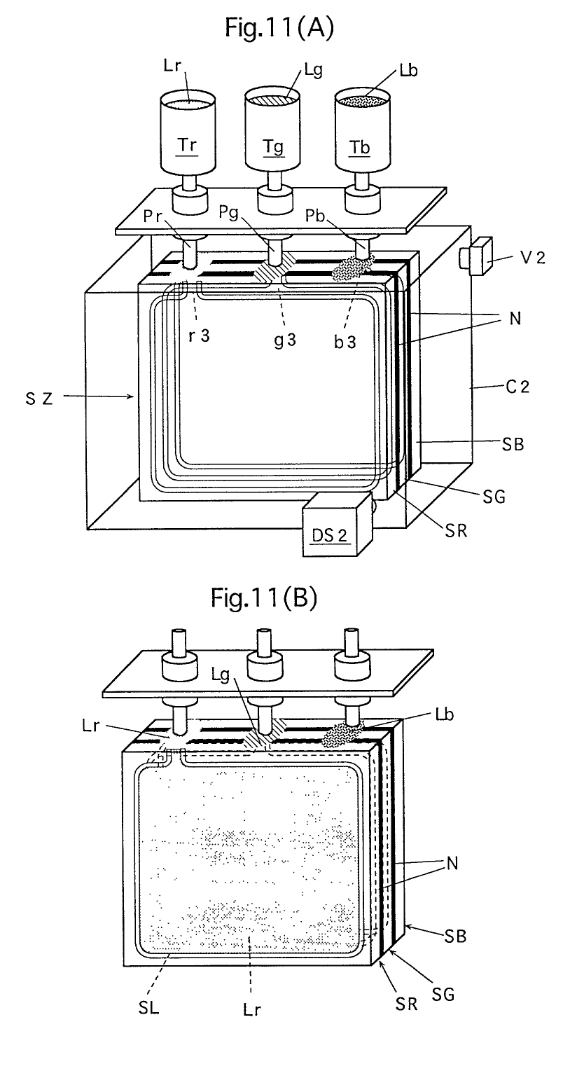

These empty cells are stacked, and are adhered together by the transparent adhesive sheets N each arranged between the neighboring cells so that a multilayer empty cell structure SZ shown in FIG. 11(A) is formed. In the multilayer empty cell structure SZ, the liquid crystal material inlets r3, g3 and b3 are located in different positions on the same side (i.e., upper side) of the structure SZ.

The multilayer empty cell structure SZ is disposed in a vacuum chamber C2, and the liquid crystal material inlets r3, g3 and b3 are located under supply pipes Pr, Pg and Pb of the liquid crystal materials Lr, Lg and Lb, respectively.

The pipes Pr, Pg and Pb are connected to tanks Tr, Tg and Tb, which are located outside the vacuum chamber C2, and accommodate the liquid crystal materials Lr, Lg and Lb, respectively.

An exhaust device DS2 is connected to the chamber C2. The vacuum chamber C2 is provided with a nitrogen gas inlet valve V2, which is connected to a nitrogen gas source (not shown).

The exhaust device DS2 operates to reduce the pressure in the vacuum chamber and attain a predetermined vacuum atmospheric pressure of about 10⁻³ Torr. Then, the liquid crystal materials Lr, Lg and Lb, which are supplied from the tanks Tr, Tg and Tb, are disposed over the inlets r3, g3 and b3, respectively.

Thereafter, the valve V2 is opened to introduce the nitrogen gas into the vacuum chamber C2, and thereby a substantially atmospheric pressure is attained in the vacuum chamber. Thereby, the liquid crystal materials Lr, Lg and Lb are supplied through the inlets r3, g3 and b3 into the empty cells by the pressure differences between the liquid crystal material ambient pressure and the internal pressures of the empty cells SR, SG and SB, respectively (see FIG. 11(B)).

Thereafter, each inlet is closed by the sealant Photolec (produced by Sekisui Finechemical Co., Ltd.). In this manner, the multilayer liquid crystal display element is obtained.

According to the example 3, the predetermined liquid crystal materials are simultaneously arranged on the liquid crystal material inlets of the respective empty cells of the multilayer empty cell structure SZ, and are simultaneously supplied into the respective empty cells. Therefore, the time required for supplying the liquid crystal materials can be reduced. Further, the smearing of the outer surface of the multilayer liquid crystal display element with the liquid crystal material can be suppressed, and the steps for cleaning and removing the smear can be reduced.

### EXAMPLE 4

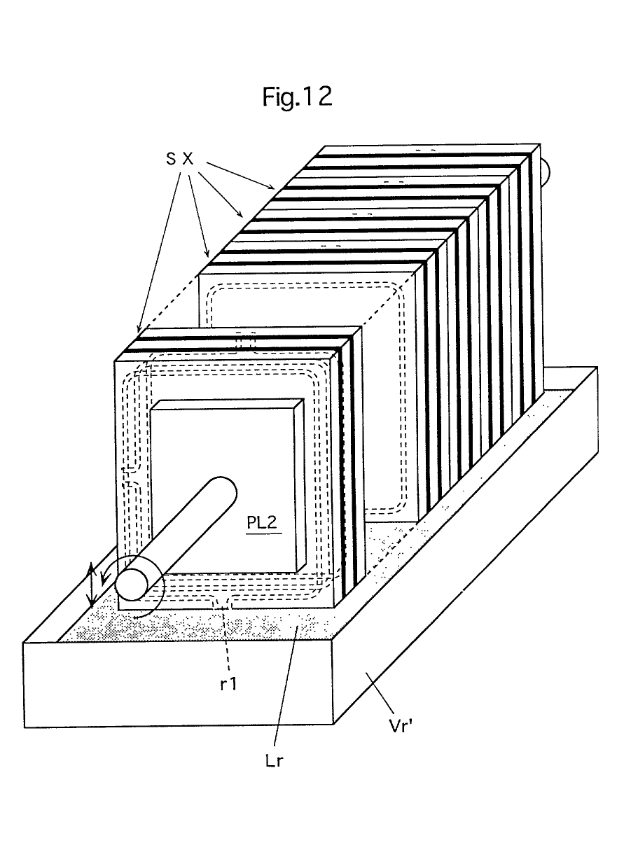

The multilayer empty cell structures SX, which are prepared in the example 1 and are one hundred in number, are stacked and held between paired plates PL2 (only one is shown) as shown in FIG. 12. Similarly to the example 1, these are arranged in a vacuum chamber (not shown), and the stacked multilayer empty cell structures SX are moved by a rotating and vertically moving mechanism similar to that in example 1 so that all the liquid crystal material inlets r1 of the empty cells SR of the respective multilayer empty cell structures SX are simultaneously immersed in the liquid crystal material Lr of a container Vr1. Thereby, the liquid crystal material is simultaneously vacuum-supplied into the empty cells SR, and each inlet is closed by the sealant.

Likewise, each of the liquid crystal materials Lg and Lb is simultaneously supplied into the corresponding empty cells SG or SB of the respective multilayer empty cell structures SX, and each inlet is closed by the sealant.

In this manner, the hundred multilayer liquid crystal display elements can be produced efficiently.

Since neither the liquid crystal material nor the sealant adheres to the surface(s) of each multilayer liquid crystal display element covered with the neighboring multilayer liquid crystal display element(s), the time required for the cleaning and removing step can be reduced.

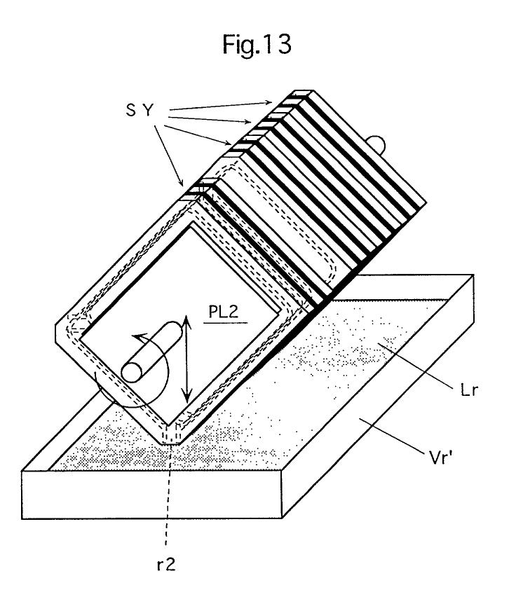

The method of producing the multilayer liquid crystal display element of the example 4 can be applied to the producing of the multilayer liquid crystal display element employing the multilayer empty cell structure SY (FIG. 7) prepared in the example 2, as shown in FIG. 13.

### EXAMPLE 5

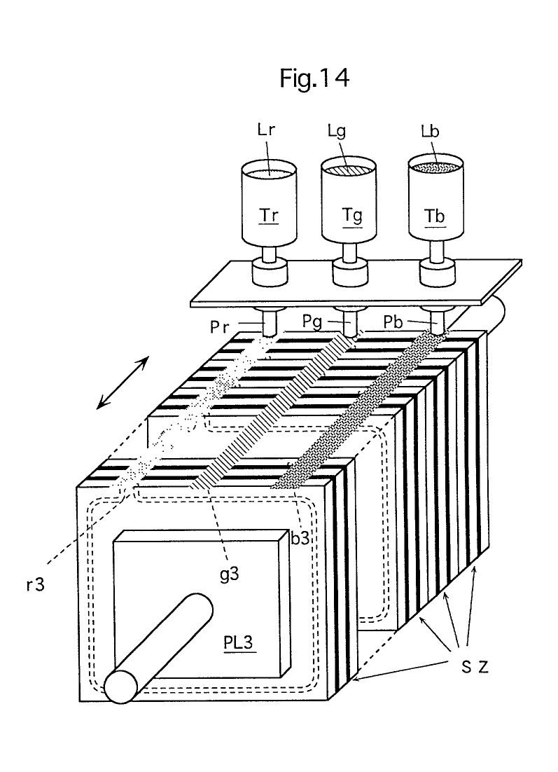

The multilayer empty cell structures SZ, which are prepared in the example 3 and are one hundred in number, are stacked and held between paired plates PL3 (only one is shown) as shown in FIG. 14. Similarly to the example 3, these are arranged in a vacuum chamber (no shown). While moving the multilayer empty cell structures SZ thus stacked and held in the direction of alignment of the liquid crystal material inlets r3 (i.e., alignment of the liquid crystal material inlets g3 and b3), the liquid crystal materials Lr, Lg and Lb, which are supplied from the tanks Tr, Tg and Tb, are disposed over the groups of inlets r3, g3 and b3, respectively.

Then, the nitrogen gas is supplied into the vacuum chamber to achieve substantially the atmospheric pressure in the vacuum chamber, whereby the predetermined liquid crystal material is simultaneously supplied into the respective empty cells of the multilayer empty cell structures SZ. Thereafter, each inlet is closed with the sealant.

In this manner, the hundred multilayer liquid crystal display elements can be produced efficiently.

Since neither the liquid crystal material nor the sealant adheres to the surface(s) of each multilayer liquid crystal display element covered with the neighboring multilayer liquid crystal display element(s), the time required for the cleaning and removing step can be reduced.

### EXAMPLE 6

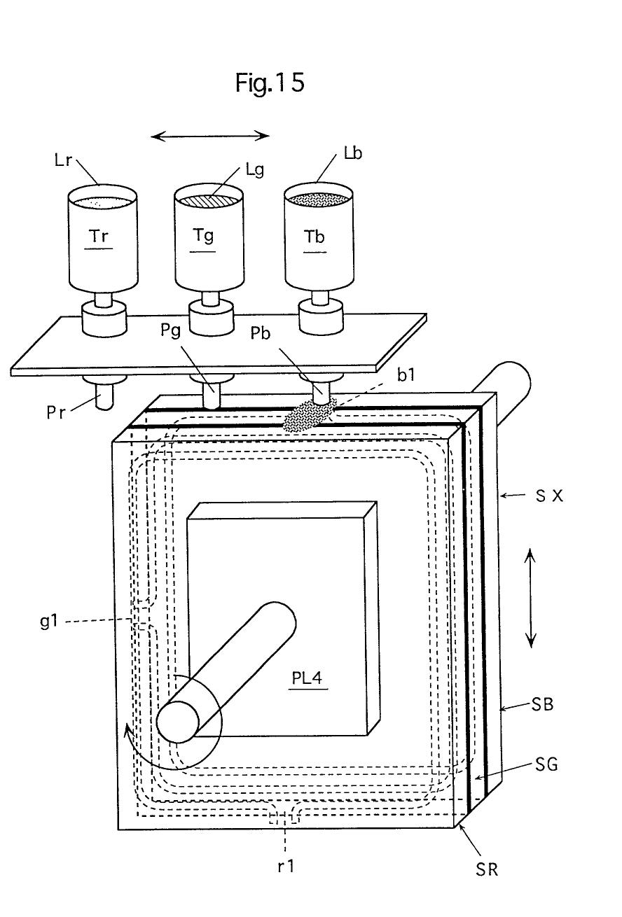

The multilayer empty cell structure SX, which is prepared in the example 1, is held between a pair of plates PL4 (only one is shown) as shown in FIG. 15, and is arranged in the vacuum chamber (not shown) coupled to the liquid crystal material tanks Tr, Tg and Tb similar to those of the example 3 (FIGS. 11(A) and 11(B)). The cell structure SX is appropriately rotated and vertically moved by a rotating and moving mechanism (not shown). Also, a horizontally moving mechanism (not shown) for the tanks appropriately and horizontally moves the tank group, Thereby, the liquid crystal material inlet (e.g., the inlet r1 of the empty cell SR) is positioned in the predetermined position and is directed upward, and the liquid crystal material Lr is arranged on the inlet r1. Then, the liquid crystal material is vacuum-supplied into the cell SR, and subsequently the inlet is closed by the sealant.

Likewise, the cell structure SX is appropriately rotated and moved upward or downward, and the tank group is appropriately and horizontally moved. Thereby, the liquid crystal material inlet g1 of the empty cell SG is positioned in the same predetermined position and is directed upward, and the liquid crystal material Lg is arranged on the inlet g1. Then, the liquid crystal material is vacuum-supplied into the cell SG, and subsequently the inlet is closed by the sealant.

In a similar manner, the liquid crystal material Lb is vacuum-supplied into the remaining empty cell SB, and then the inlet is closed by the sealant.

In this manner, the multilayer liquid crystal display element is completed.

This method of the example 5 can be applied also to the multilayer empty cell structure SY formed in the example 2 and others.

The plurality of multilayer empty cell structures SX or SY may be stacked and held between the plates PL4, and may be moved in the direction of arrangement (alignment) of the liquid crystal material inlets, similarly to the example 5 (see FIG. 14), during which the liquid crystal material may be simultaneously supplied into the respective cell structures SX or SY.

### EXAMPLE 7

Empty cell groups, each of which includes the plurality of empty cells SR, SG or SB of the same kind formed in the example 1, are subjected to the processing of simultaneously supplying by vacuum supply the predetermined liquid crystal material into all the cells of the same group in the manner similar to that of the example 4 shown in FIG. 12 or FIG. 13, or that of the example 5 shown in FIG. 14. Thereafter, the inlet of each cell is closed by the sealant.

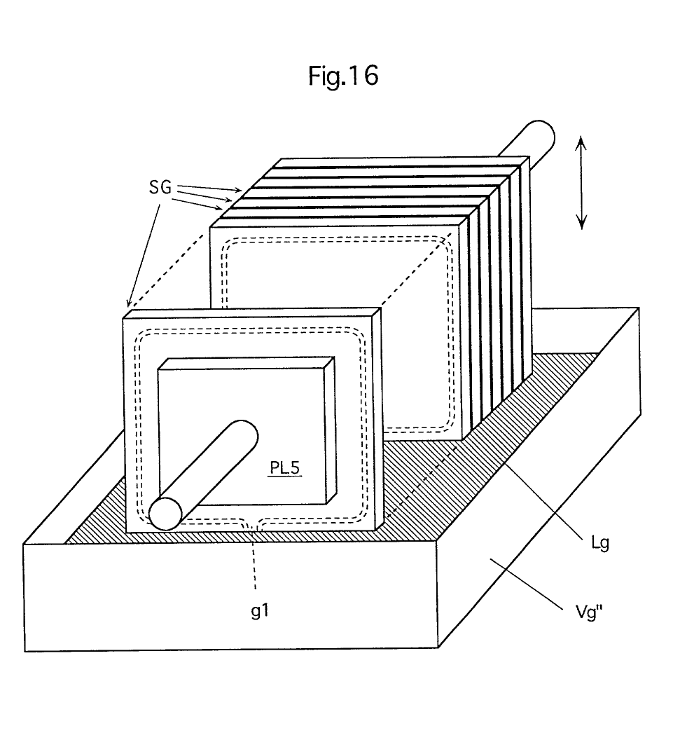

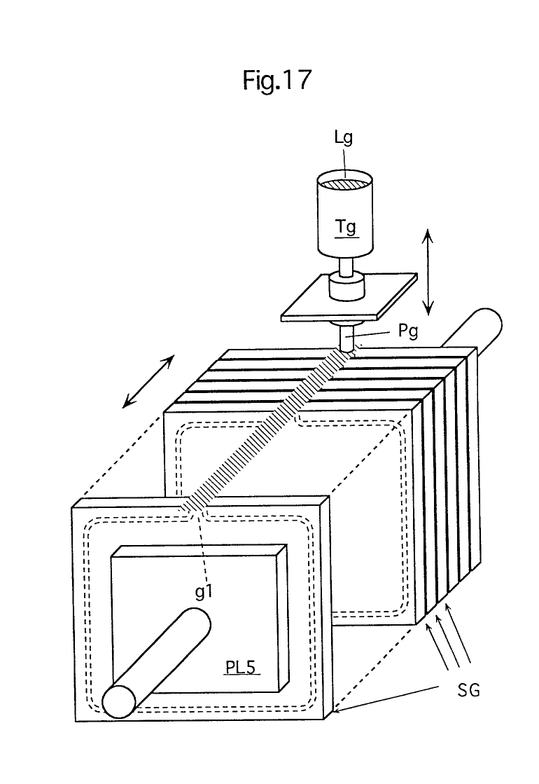

For example, the empty cells SG shown in FIG. 2(B) are processed as follows. As shown in FIG. 16 or FIG. 17, the cell group of the empty cells SG stacked together is held between paired plates PL5, and the liquid crystal material Lg is simultaneously supplied by the vacuum supply into the plurality of empty cells SG in the manner similar to that of the example 4 (see FIG. 12 or FIG. 13) or that of the example 5 (see FIG. 14). In FIG. 16, Vg″ indicates a container of the liquid crystal material Lg. Thereafter, the inlets g1 are closed by the sealant. Likewise, the predetermined liquid crystal materials are simultaneously supplied into the empty cells SR of the same group as well as the empty cells SB of the same group. Then, the inlets are closed.

From the liquid crystal display cells thus prepared, the liquid crystal display cells for forming the multilayer liquid crystal display element are selected and adhered in the stacked fashion so that the plurality of multilayer liquid crystal display elements are produced efficiently.

The method of this example 7 can be similarly applied to the empty cells in the example 2 as well as the empty cells formed in the example 3 and others, whereby the plurality of multilayer liquid crystal display elements can be produced efficiently.

In the examples already described, the black light absorber layer is formed on the outer surface of the outer substrate of the red display liquid crystal display cell (or the outer surface of the outer substrate of the empty cell SR) in the stage where the single layer of the empty cell is formed, in the stage where multilayer empty cell structure is formed or in the stage where the multilayer liquid crystal display element is formed.

According to the methods of producing the multilayer liquid crystal display element in the examples already described, each of the empty cells SR, SG and SB has only one region, which is filled with the liquid crystal material.

However, for efficient mass production of the multilayer liquid crystal display elements, the following empty cells or the following multilayer empty cell structure may be employed.

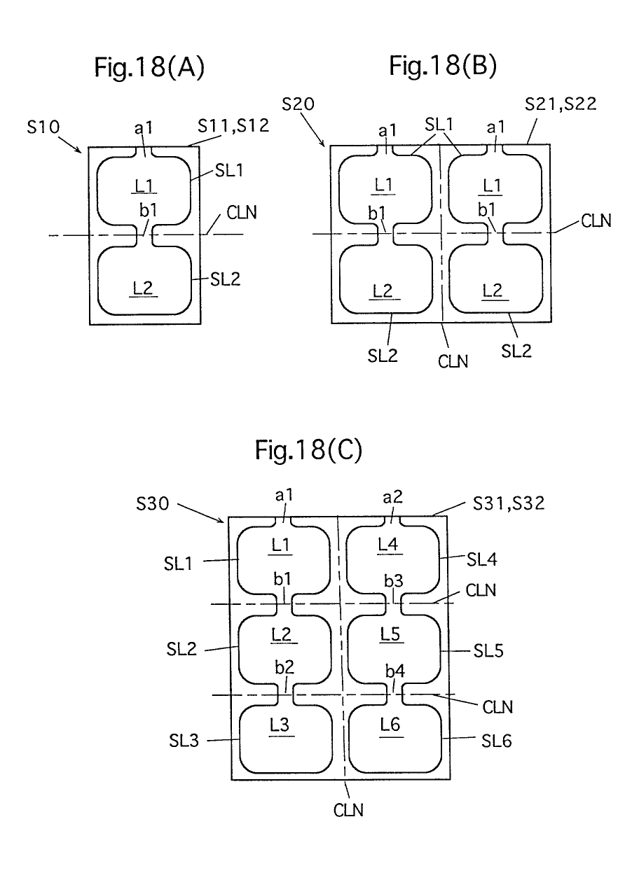

For example, an empty cell S10 shown in FIG. 18(A) may be employed.

The empty cell S10 includes a pair of transparent resin films (e.g., PC film substrates) S11 and S12 opposed to each other, and also includes a plurality of seal walls SL1 and SL2, which surround two predetermined liquid crystal material filling regions L1 and L2 between the films S11 and S12, and are held between the substrates. In the empty cell S10, the seal wall SL1 has an liquid crystal material inlet a1 which is externally opened, and the seal wall SL2 has a liquid crystal material inlet b1 The liquid crystal material filling region L2 surrounded by the seal wall SL2 is continuous to the seal wall SL1 via the portion of the inlet b1, and is in communication with the region L1 surrounded by the seal wall SL1.

Other empty cells such as empty cells S20 and S30 shown in FIGS. 18(B) and 18(C) may be employed. The empty cell S20 has such a structure that the empty cells shown in FIG. 18(A) are arranged on the left and right, and the film substrates thereof are integrally formed. The film substrates are indicated by S21 and S22.

The empty cell S30 includes a pair of transparent resin films (e.g., PC film substrates) S31 and S32 opposed to each other, and also includes a plurality of seal walls SL1-SL6, which surround six liquid crystal material filling regions L1-L6 between the films S31 and S32, and are held between the substrates. In this empty cell S30, the seal walls SL1 and SL4 have the liquid crystal material inlets al and a2, which are opened externally, respectively. The seal walls SL2, SL3, SL5 and SL6 have liquid crystal material inlets b1, b2, b3 and b4, respectively. The liquid crystal material filling region L2 surrounded by the seal wall SL2 is continuous to the region L1 via the inlet b1 The liquid crystal material filling region L3 surrounded by the seal wall SL3 is continuous to the region L1 via the inlet b2 and the region L2. Likewise, the liquid crystal material filling regions L5 and L6 surrounded by the seal walls SL5 and SL6 are continuous to the region L4 via the inlets b3 and b4, respectively.

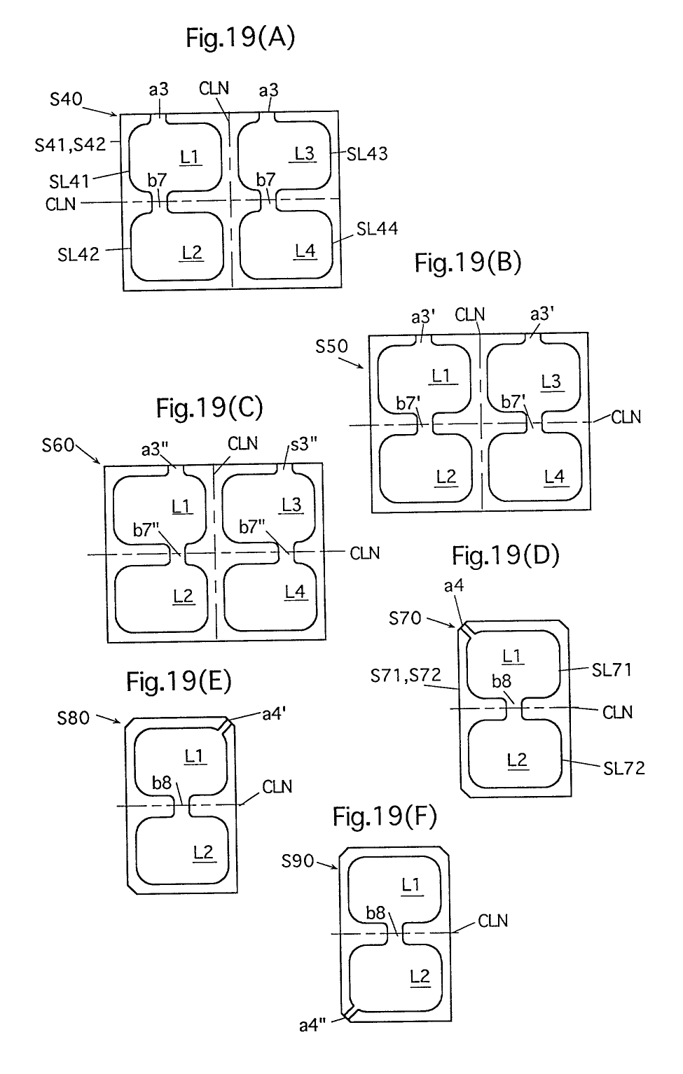

Empty cells S40, S50 and S60 shown in FIGS. 19(A)-19(C) may be employed.

The empty cell S40 includes a pair of transparent resin films (e.g., PC film substrates) S41 and S42 opposed to each other, and also includes a plurality of seal walls SL41˜SL44, which surround predetermined four liquid crystal material filling regions L1-L4 between the films S41 and S42, and are held between the substrates. In this empty cell S40, the left and right seal walls SL41 and SL43 at the upper level have liquid crystal material inlets a3 opened externally, respectively, and the left and right seal walls SL42 and SL44 at the lower level have the liquid crystal material inlets b7, respectively. The liquid crystal material filling region L2 surrounded by the seal wall SL42 is continuous to the seal wall SL41 via the portion of the inlet b7, and is in communication with the region L1 surrounded by the seal wall SL41. Likewise, the liquid crystal material filling region L4 surrounded by the seal wall SL44 is continuous to the seal wall SL43 via the portion of the inlet b7, and is in communication with the region L3 surrounded by the seal wall SL43.

In the empty cell S40, each liquid crystal material inlet is located in the left position on the upper side of the corresponding liquid crystal material filling region.

The empty cell S50 has the same structure as the empty cell S40 except for that the liquid crystal material inlets a3′ and b71 are located in central positions on the upper sides of the corresponding liquid crystal material filling regions, respectively.

The empty cell S60 has the same structure as the empty cell S40 except for that the liquid crystal material inlets a3″ and b7″ are located in right positions on the upper sides of the corresponding liquid crystal material filling regions, respectively.

Empty cells S70, S80 and S90 shown in FIGS. 19(D), 19(E) and 19(F) may be employed.

The empty cell S70 includes a pair of transparent resin films (e.g., PC film substrates) S71 and S72 opposed to each other, and also includes a plurality of seal walls SL71 and SL72, which surround predetermined two liquid crystal material filling regions L1 and L2 between the films S71 and S72, and are held between the substrates. In this empty cell S70, the seal wall SL71 at the upper level has a liquid crystal material inlet a4 opened externally, and the seal wall SL72 at the lower level has a liquid crystal material inlet b8. The liquid crystal material filling region L2 surrounded by the seal wall SL72 is continuous to the seal wall SL71 via the portion of the inlet b8, and is in communication with the region L1 surrounded by the seal wall SL71.

In the empty cell S70, the liquid crystal material inlet a4 is located in the upper left corner of the corresponding liquid crystal material filling region L1.

The empty cell S80 has the same structure as the empty cell S70 except for that the liquid crystal material inlet a′ is located in the upper right corner of the corresponding liquid crystal material filling region L1.

The empty cell S90 has the same structure as the empty cell S70 except for that the liquid crystal material inlet a4″ is located in the lower left corner of the corresponding liquid crystal material filling region L2.

In addition to the empty cells shown in FIGS. 18(A)-18(C) and FIGS. 19(A)-19(F), such empty cells can be widely employed that are prepared by arranging a plurality of seal walls between a pair of substrates opposed together to surround a plurality of predetermined liquid crystal material filling regions, each of the seal walls has at least one liquid crystal material inlet, at least one of the liquid crystal material inlets of the plurality of seal walls is externally opened, and the liquid crystal material filling region(s) surrounded by the seal wall(s) not provided with the externally opened liquid crystal material inlet is in communication with at least one of the liquid crystal material filling region(s) surrounded by the seal wall(s) having the externally opened liquid crystal material inlet.

In the case of employing the empty cells described above, the second, fourth or sixth type of method already described may be implemented to form the multilayer liquid crystal display elements.

In the case where one kind of empty cells S10-S90 shown in FIGS. 18(A)-18(C) and 19(A)-19(F) are employed, the plurality of empty cells each having the externally opened liquid crystal material inlet(s) at the same position(s) may be stacked and held, and the empty cell group thus prepared may be subjected to the processing of the example 7 shown in FIGS. 16 and 17 to supply simultaneously the predetermined liquid crystal material by vacuum supply into the liquid crystal material filling regions of these empty cells. Then, the externally opened inlets are closed by the sealant so that the liquid crystal display cells of the multiple-continuous type can be formed. In this manner, the liquid crystal display cells of the multiple-continuous type for red, green and blue displays are formed, and the liquid crystal display cells of the multiple-continuous type for each color display are divided into the individual liquid crystal display cells along cutting line(s) CLN extending through, e.g., the liquid crystal material inlet(s), which is (are) not opened externally. Then, each inlet is closed by the sealant so that the individual liquid crystal display cells are formed.

Among the divided liquid crystal display cells, multiple kinds of liquid crystal display cells are selected and stacked for forming the multilayer liquid crystal display element.

Alternatively, the following manner may be employed. The liquid crystal display cells of the multiple-continuous type for red, green and blue displays are stacked to form the multiple-continuous and multilayer liquid crystal display elements. This is divided into the individual multilayer liquid crystal display elements along the cutting line CLN extending through, e.g., the liquid crystal material inlets, which are not opened externally. Then, each inlet is closed by the sealant so that the individual multilayer liquid crystal display elements are formed.

A manner similar to that of the example 5 (see FIG. 14) may be employed for the empty cells of the multiple-continuous type similar to those shown in FIGS. 18(B)-18(C).

For example, three kinds of the empty cells S40-S60 shown in FIGS. 19(A)-19(C) may be stacked to form the multilayer empty cell structure. In this case, the externally opened liquid crystal material inlets a3, a3′ and a3″ are located in the different positions on the same upper side of the multilayer empty cell structure. Using this multilayer empty cell structure, the multiple-continuous type of multilayer liquid crystal display elements may be produced in a method similar to that of the example 3 (see FIGS. 11(A) and 11(B)), or in a method similar to that of the example 5 (see FIG. 14) using the plurality of multilayer empty cell structures held in the stacked fashion. In these cases, the predetermined liquid crystal materials are vacuum-supplied into the liquid crystal material filling regions of the respective empty cells, and then he externally opened liquid crystal material inlets a3, a3′ and a3″ are closed by the sealant.

Each of the multiple-continuous type of multilayer liquid crystal display elements may be divided into the individual multilayer liquid crystal display elements along the cutting line CLN extending, e.g., the liquid crystal material inlets not opened externally.

For example, the three kinds of empty cells S70-S90 shown in FIGS. 19(D)-19(F) may be stacked to form the multilayer empty cell structure. In this case, the externally opened liquid crystal material inlets a4, a4′ and a41′ are located on the different corners of the multilayer empty cell structure, respectively. The empty cells S70, S80 and S90 as well as the multilayer empty cell structure may be formed to locate the externally opened liquid crystal material inlets a4, a4′ and a4″ on the different sides of the multilayer empty cell structure, respectively.

Using the above multilayer empty cell structure, the multiple-continuous type of multilayer liquid crystal display elements may be produced in a method similar to that of the example 1 (see FIGS. 4 and 5(A)-5(C)) or the example 2 (see FIGS. 8 and 9(A)-9(C)), or in a method similar to that of the example 4 (see FIGS. 12 and 13) using the plurality of multilayer empty cell structures held in the stacked fashion. In these cases, the predetermined liquid crystal materials are vacuum-supplied into the liquid crystal material filling regions of the respective empty cells, and then the externally opened liquid crystal material inlets a4, a4′ and a4″ are closed by the sealant.

Each of the multiple-continuous type of multilayer liquid crystal display elements may be divided into the individual multilayer liquid crystal display elements along the cutting line CLN extending, e.g., the liquid crystal material inlets not opened externally.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of producing a multilayer liquid crystal display element including a plurality of liquid crystal display cells stacked together and each filled with a liquid crystal material, comprising the steps of:
(a) forming a multilayer empty cell structure by stacking a plurality of empty cells each including a pair of substrates opposed together and each having a peripheral portion between the substrates sealed except for at least one liquid crystal material inlet opened externally; and
(b) supplying the liquid crystal materials by a vacuum supply through said liquid crystal material inlets into the empty cells, respectively, wherein said empty cells formed in the step (a) are provided at circumferentially different positions with the liquid crystal material inlets, respectively.

2. A method as claimed in claim 1, wherein
the vacuum supply of the liquid crystal material in the step (b) is performed by successively locating the liquid crystal material inlets of the respective empty cells at a liquid crystal material supply region in a predetermined position.

3. A method as claimed in claim 1, wherein
the step (a) is performed to form the multilayer empty cell structure such that the externally opened liquid crystal material inlet of each of the empty cells is located on a side or a corner of the multilayer empty cell structure different from sides and corners having the externally opened liquid crystal material inlet of the other empty cells.

4. A method as claimed in claim 2, wherein
the vacuum supply of the liquid crystal material into each of the empty cells in the step (b) is performed by arranging said multilayer empty cell structure in a predetermined vacuum atmosphere for achieving a predetermined vacuum state in the empty cell to be filled with the liquid crystal material, sinking said externally opened liquid crystal material inlet of the empty cell within a container of the liquid crystal material to be supplied into the empty cell, and increasing an ambient pressure of said liquid crystal material above the vacuum ambient pressure for supplying the liquid crystal material into the empty cell.

5. A method as claimed in claim 2, wherein
the vacuum supply of the liquid crystal material into each of the empty cells in the step (b) is performed by arranging said multilayer empty cell structure in a predetermined vacuum atmosphere for achieving a predetermined vacuum state in the empty cell to be filled with the liquid crystal material, locating said externally opened liquid crystal material inlet of the empty cell at the liquid crystal material supply region, arranging the liquid crystal material corresponding to the empty cell on said externally opened liquid crystal material inlet of the empty cell, and increasing an ambient pressure of the arranged liquid crystal material above the vacuum ambient pressure for supplying the liquid crystal material into the empty cell.

6. A method as claimed in claim 1, wherein
the empty cells of said multilayer empty cell structure formed in the step (a) are provided at different positions on the same side of the multilayer empty cell structure with the liquid crystal material inlets, and the vacuum supply of the liquid crystal material in the step (b) is performed by simultaneously locating the liquid crystal material inlets of the respective empty cells of the multilayer empty cell structure at liquid crystal material supply regions.

7. A method as claimed in claim 6, wherein
the supply of the liquid crystal material into each of the empty cells in the step (b) is performed by arranging the multilayer empty cell structure in a predetermined vacuum atmosphere for achieving a predetermined vacuum state in the empty cells, arranging the predetermined liquid crystal materials corresponding to the respective empty cells on the externally opened liquid crystal material inlets of the respective empty cells, and increasing an ambient pressure of the arranged liquid crystal materials above said vacuum ambient pressure for supplying said liquid crystal materials into the empty cells.

8. A method as claimed in claim 1, wherein
the step (a) is executed to form a plurality of the multilayer empty cell structures, said plurality of multilayer empty cell structures are held in a stacked fashion and the step (b) is performed simultaneously for all the multilayer empty cell structures.

9. A method as claimed in claim 1, wherein
the liquid crystal materials have mutually different compositions, respectively.

10. A method as claimed in claim 1, wherein
said liquid crystal material supplied into each of the empty cells includes a chiral nematic liquid crystal.

11. A method of producing a multilayer liquid crystal display element including a plurality of liquid crystal display cells stacked together and each filled with a liquid crystal material, comprising the steps of:
(a) forming a multilayer empty cell structure by stacking empty cells each prepared by arranging a seal wall between a pair of substrates opposed together to surround a plurality of liquid crystal material filling regions, each of said seal walls having at least one liquid crystal material inlet, at least one of said liquid crystal material inlets of said plurality of seal walls being externally opened, said liquid crystal material filling region(s) surrounded by the seal wall(s) not provided with the externally opened liquid crystal material inlet being in communication with at least one of the liquid crystal material filling region(s) surrounded by the seal wall(s) having the externally opened liquid crystal material inlet, and said externally opened liquid crystal material inlet of each of said empty cells being arranged on a periphery of the multilayer empty cell structure, and being located at a position different from those of the other empty cells;
(b) supplying said liquid crystal materials by a vacuum supply through said externally opened liquid crystal material inlets into said empty cells, respectively; and
(c) dividing said multilayer cell structure into the individual liquid crystal display elements after the step (b).

12. A method as claimed in claim 11, wherein
the vacuum supply of the liquid crystal material in said liquid crystal material supplying step is performed by successively locating the liquid crystal material inlets of the respective empty cells at a liquid crystal material supply region in a predetermined position.

13. A method of producing a multilayer liquid crystal display element as claimed in claim 11, wherein
the step (a) is performed to form the multilayer empty cell structure such that the externally opened liquid crystal material inlet of each of the empty cells is located on a side or a corner of the multilayer empty cell structure different from sides and corners having the externally opened liquid crystal material inlet of the other empty cells.

14. A method as claimed in claim 12, wherein
the vacuum supply of the liquid crystal materials into the empty cells in the step (b) is performed by arranging said multilayer empty cell structure in a predetermined vacuum atmosphere for achieving a predetermined vacuum state in the empty cell to be filled with the liquid crystal material, sinking said externally opened liquid crystal material inlet of the empty cell in said liquid crystal material within a container of the liquid crystal material to be supplied into the empty cell, and increasing an ambient pressure of said liquid crystal material above the vacuum ambient pressure for supplying the liquid crystal material into the empty cell.

15. A method claimed in claim 12, wherein
the vacuum supply of the liquid crystal material into each of the empty cells in the step (b) is performed by arranging said multilayer empty cell structure in a predetermined vacuum atmosphere for achieving a predetermined vacuum state in the empty cell to be filled with the liquid crystal material, locating said externally opened liquid crystal material inlet of the empty cell at the liquid crystal material supply region in the predetermined position, arranging the predetermined liquid crystal material corresponding to the empty cell on said externally opened liquid crystal material inlet of the empty cell, and increasing an ambient pressure of the arranged liquid crystal material above the vacuum ambient pressure for supplying the liquid crystal material into the empty cell.

16. A method as claimed in claim 11, wherein
the empty cells of said multilayer empty cell structure formed in the step (a) are provided at different positions on the same side of the multilayer empty cell structure with the externally opened liquid crystal material inlets, and the vacuum supply of the liquid crystal material in said liquid crystal material supplying step is performed by simultaneously locating the externally opened liquid crystal material inlets of the respective empty cells of the multilayer empty cell structure at a liquid crystal material supply region in a predetermined position.

17. A method as claimed in claim 16, wherein
the vacuum supply of the liquid crystal material into each of the empty cells in the step (b) is performed by arranging the multilayer empty cell structure in a predetermined vacuum atmosphere for achieving a predetermined vacuum state in the empty cells, arranging the predetermined liquid crystal materials corresponding to the respective empty cells on the externally opened liquid crystal material inlets of the respective empty cells, and increasing an ambient pressure of the arranged liquid crystal materials above said vacuum ambient pressure for supplying said liquid crystal materials into the empty cells.

18. A method of producing a multilayer liquid crystal display element as claimed in claim 11, wherein
the step (a) is executed to form a plurality of the multilayer empty cell structures, said plurality of multilayer empty cell structures are held in a stacked fashion and the step (b) is performed simultaneously for all the multilayer empty cell structures.

19. A method of producing a multilayer liquid crystal display element as claimed in claim 11, wherein
the liquid crystal materials have mutually different compositions.

20. A method of producing a multilayer liquid crystal display element as claimed in claim 11, wherein
said liquid crystal material supplied into each of the empty cells includes a chiral nematic liquid crystal.

21. A method of producing a multilayer liquid crystal display element including a plurality of liquid crystal display cells stacked together and each filled with a liquid crystal material, comprising the steps of:
(a) forming a plurality of empty cell groups, each of the groups including a plurality of empty cells of a same kind, each of the empty cells of each of the groups having a pair of substrates opposed together and a sealing applied to a peripheral portion between the substrates except for at least one liquid crystal material inlet opened externally;
(b) forming said liquid crystal display cells by stacking and holding the plurality of empty cells of the same kind, and simultaneously supplying said liquid crystal material by a vacuum supply through said liquid crystal material inlets into the stacked empty cells belonging to each of the empty cell groups; and
(c) forming said multilayer liquid crystal display element by selecting and stacking the multiple kinds of liquid crystal display cells among the liquid crystal display cells obtained in the step (b).

22. A method as claimed in claim 21, wherein
the vacuum supply of said liquid crystal material into each of the stacked empty cells of the same group is performed, in the step (b), by arranging each group of the stacked empty cells in a predetermined vacuum atmosphere for achieving a predetermined vacuum state in the empty cells belonging to the same cell group, simultaneously sinking the externally opened liquid crystal material inlets of the empty cells in the liquid crystal material within a container of the liquid crystal material to be supplied into the empty cells, and increasing an ambient pressure of said liquid crystal material above the vacuum ambient pressure for supplying the liquid crystal material into the empty cells.

23. A method as claimed in claim 21, wherein
the vacuum supply of the liquid crystal material into each of the stacked empty cells of the same group is performed, in the step (b), by arranging the empty cells in a predetermined vacuum atmosphere for achieving a predetermined vacuum state in the empty cells belonging to the same group, arranging the liquid crystal material on the externally opened liquid crystal material inlets of the empty cells, and increasing an ambient pressure of said arranged liquid crystal material above the vacuum ambient pressure for supplying the liquid crystal material into the empty cells.

24. A method as claimed in claim 21, wherein
the liquid crystal materials have mutually different compositions.

25. A method as claimed in claim 21, wherein
said liquid crystal material supplied into each of the empty cells includes a chiral nematic liquid crystal.

26. A method of producing a multilayer liquid crystal display element including a plurality of liquid crystal display cells stacked together and each filled with a liquid crystal material, comprising the steps of:
(a) forming multiple kinds of empty cell groups, each of the groups including a plurality empty cells of a same kind, each of the empty cells of each of the groups prepared by arranging a seal wall between a pair of substrates opposed together to surround a plurality of liquid crystal material filling regions, each of said seal walls having at least one liquid crystal material inlet, at least one of said liquid crystal material inlets of each seal wall being externally opened, the liquid crystal material filling region(s) surrounded by the seal wall not provided with the externally opened liquid crystal material inlet being in communication with at least one of the liquid crystal material filling region(s) surrounded by the seal wall having the externally opened liquid crystal material inlet;
(b) forming liquid crystal display cells of multi-continuous type by stacking and holding the plurality of empty cells of the same kind, and simultaneously supplying the liquid crystal material by vacuum supply through the externally opened liquid crystal material inlets into the stacked empty cells belonging to each of the empty cell groups; and
(c) forming the multilayer liquid crystal display elements by dividing the liquid crystal display cells of the multiple continuous type into the individual liquid crystal display cells, and by selecting and stacking the multiple kinds of the liquid crystal display cells, or stacking the plurality of liquid crystal display cells of the multiple continuous type to form multilayer liquid crystal display elements of multiple continuous type, and dividing said multilayer liquid crystal display elements of the multiple continuous type into the individual multilayer liquid crystal display elements.

27. A method as claimed in claim 26, wherein
the supply of said liquid crystal material into each of the stacked empty cells of the same group is performed, in the step (b), by arranging each group of the stacked empty cells in a predetermined vacuum atmosphere for achieving a predetermined vacuum state in the empty cells belonging to the same cell group, simultaneously sinking the externally opened liquid crystal material inlets of the empty cells in the liquid crystal material within a container of the liquid crystal material to be supplied into the empty cells, and increasing an ambient pressure of said liquid crystal material above the vacuum ambient pressure for supplying the liquid crystal material into the empty cells.

28. A method as claimed in claim 26, wherein
the supply of the liquid crystal material into each of the stacked empty cells of the same group is performed, in the step (b), by arranging the empty cells in a predetermined vacuum atmosphere for achieving a predetermined vacuum state in the empty cells belonging to the same group, arranging the liquid crystal material on the externally opened liquid crystal material inlets of the empty cells, and increasing an ambient pressure of said arranged liquid crystal material above the vacuum ambient pressure for supplying the liquid crystal material into the empty cells.

29. A method as claimed in claim 26, wherein
the liquid crystal materials have mutually different compositions are supplied into the different kinds of empty cells, respectively.

30. A method as claimed in claim 26, wherein
said liquid crystal material supplied into each of the empty cells includes a chiral nematic liquid crystal.

31. A liquid crystal display element comprising:
a plurality of liquid crystal display cells stacked together, each of the liquid crystal cells comprising:
a liquid crystal filled between a pair of substrates; and
a seal wall provided between the pair of substrates, surrounding the liquid crystal for preventing leakage of the liquid crystal, and being provided with a closed opening that had been originally provided for filling the liquid crystal in a space defined by the substrates and the seal wall, wherein
the closed openings of the liquid crystal display cells are provided at positions different from each other with respect to a circumferential direction of the liquid crystal display element.

32. A liquid crystal display element as claimed in claim 31, wherein
the liquid crystal display element has a polygonal shape.

33. A liquid crystal display element as claimed in claim 32, wherein
the closed openings of the liquid crystal display cells are provided on the same side of the liquid crystal display element.

34. A liquid crystal display element as claimed in claim 32, wherein
the closed openings of the liquid crystal display cells are provided on different sides of the liquid crystal display element.

35. A liquid crystal display element as claimed in claim 32, wherein
the closed openings of the liquid crystal display cells are provided on different corners of the liquid crystal display element.

36. A liquid crystal display element as claimed in claim 31, wherein compositions of the liquid crystals of the liquid crystal display cells are different from each other.

37. A liquid crystal display element as claimed in claim 31, wherein
the liquid crystal of each of the liquid crystal display cells includes a chiral nematic liquid crystal.
